(19) United States
(12) Patent Application Publication
(10) Pub. No.: US 2024/0170691 A1
(43) Pub. Date: May 23, 2024

(54) BIPOLAR PLATES WITH FLOW CHANNELS FOR DIRECT DIFFUSION LAYER REACTANT INJECTION

(71) Applicant: HYDROGENICS CORPORATION, Mississauga (CA)

(72) Inventors: Salvatore RANIERI, Etobicoke (CA); Justin Roberto RIZZI, Oshawa (CA); Nathaniel Ian JOOS, Toronto (CA); Nan GE, Toronto (CA)

(21) Appl. No.: 18/503,975

(22) Filed: Nov. 7, 2023

Related U.S. Application Data
(60) Provisional application No. 63/383,358, filed on Nov. 11, 2022.

(51) Int. Cl. H01M 8/0265; H01M 8/04082

(52) U.S. Cl. CPC H01M 8/0265; H01M 8/04201

(57) ABSTRACT

A bipolar plate assembly for a fuel cell includes a first bipolar sheet having elongated lands formed thereon each defining secondary channels therein. The first bipolar sheet further includes primary channels formed between adjacent elongated lands. The first bipolar sheet includes an active area at which fluids flowing through the primary and secondary channels electrochemically react with an adjacent gas diffusion layer of the fuel cell. Top surfaces of the elongated lands include injectors formed as a hole in the top surfaces and located in the active area of the first bipolar sheet. Fluid flowing through the secondary channels is forced through the injectors, subsequently into the adjacent gas diffusion layer, and subsequently into and adjacent primary channel.

### CROSS-REFERENCE TO RELATED APPLICATIONS

This nonprovisional application claims the benefit and priority, under 35 U.S.C. § 119(e) and any other applicable laws or statues, to U.S. Provisional Patent Application Ser. No. 63/383,358 filed on Nov. 11, 2022, the entire disclosure of which is hereby expressly incorporated herein by reference.

### TECHNICAL FIELD

The present disclosure generally relates to fuel cell assemblies, and in particular, bipolar plates of fuel cell assemblies.

### BACKGROUND

A single fuel cell is one of many repeating units of a fuel cell stack that may provide power or energy for personal and/or industrial use. The typical proton exchange membrane (PEM) fuel cell is comprised of many fuel cell assemblies compressed and bound into a fuel cell stack. In many mobility applications, reactants supplied to the fuel cell are pure hydrogen for an anode gas diffusion layer and an oxidant for a cathode gas diffusion layer, such as oxygen. A cooling system is often required to provide a heat sink to manage excess heat produced during electrochemical reactions and to keep the fuel cell at an appropriate temperature during operation.

In general, the higher the concentration of oxygen available at the reaction site (i.e., the cathode side), the better the fuel cell will perform. As the reactant(s) travel down the length of a channel on a bipolar plate of the fuel cell (from an inlet toward an outlet), the concentration decreases as oxygen molecules are exchanged with water to support the reaction of the adjacent gas diffusion layer. High oxygen concentration fluctuations, caused by large oxygen gradients, may have adverse spatial effects with regards to the fuel cell active area. Moreover, an effective fuel cell design must be robust to excessive water generation and be able to operate effectively under aggressive humidity conditions. Accordingly, it would be advantageous to provide a fuel cell assembly, and in particular, a bipolar plate or bipolar plates designed to achieve substantially uniform concentration of oxygen and to manage water concentrations.

### SUMMARY

Embodiments of the present invention are included to meet these and other needs.

In one aspect, described herein, a bipolar plate assembly for a fuel cell includes a first bipolar sheet defining a first sheet surface. The first bipolar sheet includes a plurality of elongated lands that are raised away from the first sheet surface and formed as hollow channels so as to each define a first sheet secondary channel therein. The plurality of elongated lands extend from an inlet portion of the first bipolar sheet to an exhaust portion of the first bipolar sheet. The plurality of elongated lands include a first elongated land having a first land top surface and a second elongated land having a second land top surface. A first sheet primary channel is formed between the first and second elongated lands. The first bipolar sheet includes an active area at which fluids flowing through the first sheet primary channel and first sheet secondary channel are operable to electrochemically react with an adjacent gas diffusion layer of the fuel cell. The first land top surface includes a first injector formed as a hole in the first land top surface and located in the active area of the first bipolar sheet. A first fluid flowing through the first sheet secondary channel of the first elongated land is forced through the first injector, subsequently into the adjacent gas diffusion layer, and subsequently into the first sheet primary channel.

In some embodiments, the bipolar plate assembly may further include a second bipolar sheet defining a second sheet surface and arranged on an underside of the first bipolar sheet. In some embodiments, the second bipolar sheet may include a plurality of elongated lands that are raised away from the second sheet surface in a second direction opposite a first direction in which the plurality of elongated lands of the first bipolar sheet extend. In some embodiments, the plurality of elongated lands of the second bipolar sheet may be formed as hollow channels so as to each define a second sheet secondary channel therein. In some embodiments, the plurality of elongated lands of the second bipolar sheet may extend from an inlet portion of the second bipolar sheet to an exhaust portion of the second bipolar sheet. In some embodiments, the plurality of elongated lands of the second bipolar sheet may include a third elongated land having a third land top surface and a fourth elongated land having a fourth land top surface. In some embodiments, a second sheet primary channel may be formed between the third and fourth elongated lands.

In some embodiments, the third and fourth elongated lands may be aligned with the first and second elongated lands, respectively. In some embodiments, the first sheet primary channel may be aligned with the second sheet primary channel. In some embodiments, the third and fourth land top surfaces may be generally parallel with the first and second land top surfaces. In some embodiments, a bottom surface of the first sheet primary channel may be generally parallel with a bottom surface of the second sheet primary channel.

In some embodiments, the bipolar plate assembly may further include a separator plate arranged between the first and second bipolar sheets. In some embodiments, the separator plate may extend between each first sheet secondary channel and the corresponding second sheet secondary channel such that each first sheet secondary channel is separated from and selectively sealed off from the corresponding second sheet secondary channel. In some embodiments, the first sheet secondary channel defined between the first elongated land and the separator plate may include a first fluid flowing therethrough.

In some embodiments, the first fluid may be oxygen or air. In some embodiments, the oxygen or air flowing through the first sheet secondary channel defined between the first elongated land and the separator plate, through the adjacent gas diffusion layer, and into the first sheet primary channel may increase uniformity of a concentration of oxygen or air between the inlet portion and the exhaust portion of the first bipolar sheet.

In some embodiments, an input end of the first elongated land located at the input portion of the first bipolar sheet may be opened so as to allow input of the first fluid into the first sheet secondary channel of the first elongated land. In some embodiments, the second sheet secondary channel defined between the third elongated land and the separator plate may include a second fluid flowing therethrough. In some embodiments, the second fluid may be different than the first fluid.

In some embodiments, an output end of the first elongated land located at the exhaust

portion of the first bipolar sheet may be closed so as to cause a pressure drop in the fluid flowing through the first sheet secondary channel of the first elongated land such that the fluid is forced through the first injector.

In some embodiments, a size of the first injector may be based on liquid water accumulation in the bipolar plate assembly. In some embodiments, the size of the first injector may be configured to force the first fluid past an onset of liquid water accumulation that causes blockage of the adjacent gas diffusion layer.

In some embodiments, the separator plate may include a first elongated protrusion that extends generally parallel with a longitudinal extent of the first elongated land and that is raised away from a separator plate surface toward the first land top surface. In some embodiments, the first elongated protrusion may be located within the first sheet secondary channel of the first elongated land. In some embodiments, the first elongated protrusion may be configured to reduce a volume of the first sheet secondary channel of the first elongated land.

According to a second aspect, described herein, a bipolar plate sheet for a bipolar plate of a fuel cell includes a plurality of elongated lands that are raised away from a first sheet surface of the bipolar plate sheet and formed as hollow channels so as to each define a secondary channel therein. The plurality of elongated lands includes a first elongated land having a first land top surface and a second elongated land having a second land top surface. A primary channel is formed between the first and second elongated lands. The first land top surface includes a first injector formed as a hole in the first land top surface. A first fluid flowing through the secondary channel of the first elongated land is forced through the first injector, subsequently into an adjacent gas diffusion layer, and subsequently into the primary channel.

In some embodiments, the first bipolar sheet may include an active area at which fluids flowing through the primary channel and secondary channels are operable to electrochemically react with the adjacent gas diffusion layer of the fuel cell. In some embodiments, the first injector may be located in the active area. In some embodiments, the first fluid may be a reactant of the fuel cell. In some embodiments, the first and second land top surfaces may be generally parallel with a bottom surface of the primary channel.

In some embodiments, the active area may be located between a distribution area of the bipolar plate sheet and an exhaust area of the bipolar plate. In some embodiments, the active area may include a first half located closest to the distribution area and a second half located closest to the exhaust area. In some embodiments, the first injector may be located in the second half of the active area. In some embodiments, the first land top surface may further include a second injector formed as a hole in the first land top surface and located downstream of the first injector.

According to a third aspect, described herein, a method of forming bipolar plate assembly for a fuel cell includes providing a first bipolar sheet defining a first sheet surface. The method includes forming a plurality of elongated lands that are raised away from the first sheet surface and formed as hollow channels so as to each define a first sheet secondary channel therein. The plurality of elongated lands extend from an inlet portion of the first bipolar sheet to an exhaust portion of the first bipolar sheet. The plurality of elongated lands include a first elongated land having a first land top surface and a second elongated land having a second land top surface. The method includes forming a first sheet primary channel between the first and second elongated lands. The first bipolar sheet includes an active area at which fluids flowing through the first sheet primary channel and first sheet secondary channels are operable to electrochemically react with an adjacent gas diffusion layer of the fuel cell. The method includes forming a first ejector in the first land top surface. The first injector is formed as a hole in the first land top surface and located in the active area of the first bipolar sheet. The first sheet secondary channel of the first elongated land is configured to facilitate flow of a first fluid therethrough. The first fluid is configured to be forced through the first injector, subsequently into the adjacent gas diffusion layer, and subsequently into the first sheet primary channel.

### BRIEF DESCRIPTION OF THE DRAWINGS

This disclosure will be more fully understood from the following detailed description taken in conjunction with the accompanying drawings, in which:

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2A is a cutaway perspective view of a portion of a bipolar plate assembly according to the present disclosure including first and second bipolar sheets, injectors formed in a top surface of elongated lands that extend across the first bipolar sheet of the bipolar plate assembly, and a separator plate arranged between the two bipolar sheets;

FIG. 2B is a cutaway perspective view of portions of two of the bipolar plate assemblies of FIG. 2A with a stack of gas diffusion layers and a membrane electrode assembly (MEA) between the two bipolar plate assemblies;

FIG. 3 is a top view of the entire bipolar plate assembly of FIG. 2A;

FIG. 4 is a cutaway perspective view of a portion of a typical bipolar plate assembly without a separator plate;

FIG. 5 is a cross-sectional view of the portion of two of the typical bipolar plate assemblies without a separator plate of FIG. 4 with a stack of gas diffusion layers between the two typical bipolar plate assemblies;

FIG. 6 is a non-dimensional graph of oxygen and water concentration along a primary channel of a bipolar sheet of the bipolar plate assembly of FIG. 2A;

FIG. 7 is a schematic view of an operating PEM fuel cell and gas diffusion layer and MEA assembly including water accumulation;

FIG. 8 is a cutaway perspective view of the portion of the bipolar plate assembly of FIG. 2A showing flow directions of reactants and coolant flowing through primary and secondary channels;

FIG. 9A is a cross-sectional view of the portion of the bipolar plate assembly of FIG. 2A showing flow directions of reactants and coolant flowing through the primary and secondary channels of a single-injection type of the bipolar plate assembly;

FIG. 9B is a cross-sectional view of the portion of the bipolar plate assembly of FIG. 2A showing flow directions of reactants and coolant flowing through the primary and secondary channels of a single-injection type of the bipolar plate assembly on top of the MEA and the gas diffusion layer assembly, and a dual-injection type of the bipolar plate assembly on the bottom of the MEA and the gas diffusion layer assembly;

FIG. 9C is a cutaway perspective view of the portion of the bipolar plate assembly of FIG. 2A showing a top-side up view of a single-injection type of the bipolar plate assembly;

FIG. 9D is a cutaway perspective view of the portion of the bipolar plate assembly of FIG. 2A showing an upside-down view of the single-injection type of the bipolar plate assembly;

FIG. 9E is a cutaway perspective view of the portion of the bipolar plate assembly of FIG. 2A showing a top-side up view of a dual-injection type of the bipolar plate assembly;

FIG. 9F is a cutaway perspective view of the portion of the bipolar plate assembly of FIG. 2A showing an upside-down view of the dual-injection type of the bipolar plate assembly;

FIG. 9G is a cross-sectional view of the portion of the bipolar plate assembly of FIG. 2A showing flow directions of reactants and coolant flowing through the primary and secondary channels of a dual-injection type of the bipolar plate assembly on the top and bottom of the MEA and the gas diffusion layer assembly on the left, and a single-injection type of the bipolar plate assembly on the top and bottom of the MEA and the gas diffusion layer assembly on the right;

FIG. 10 is a perspective view of another portion of the bipolar plate assembly of FIG. 2A, showing the flow of reactants through the primary and secondary channels in an inlet portion of the bipolar plate assembly;

FIG. 11 is a magnified perspective view of the bipolar plate assembly of FIG. 10, showing the flow of reactants through the primary and secondary channels in the inlet portion of the bipolar plate assembly;

FIG. 12 is a schematic view of the bipolar plate assembly of FIG. 2A, showing the injectors arranged in successively smaller sections of an active area;

FIG. 13A is a cutaway perspective view of a portion of a bipolar plate assembly according to a further aspect of the present disclosure including first and second bipolar sheets, injectors formed in a top surface of elongated lands that extend across the first bipolar sheet of the bipolar plate assembly, and a separator plate arranged between the two bipolar sheets, and showing that the separator plate includes varying elongated protrusions that extend into secondary channels formed in the elongated lands;

FIG. 13B is a cutaway perspective view of a portion of the bipolar plate assembly of FIG. 13A, showing that the separator plate includes varying elongated protrusions that extend into the secondary channels formed in the elongated lands with at least one elongated protrusion raised toward the second bipolar sheet while the other elongated protrusions are raised toward the first bipolar sheet; and

FIG. 14 is a cutaway perspective view of a portion of a bipolar plate assembly according to a further aspect of the present disclosure including first and second bipolar sheets, injectors formed in a top surface of elongated lands that extend across the first bipolar sheet of the bipolar plate assembly, and a separator plate arranged between the two bipolar sheets, and showing that the bipolar plate assembly includes connecting ducts that extend between and fluidically interconnect elongated lands.

### DETAILED DESCRIPTION

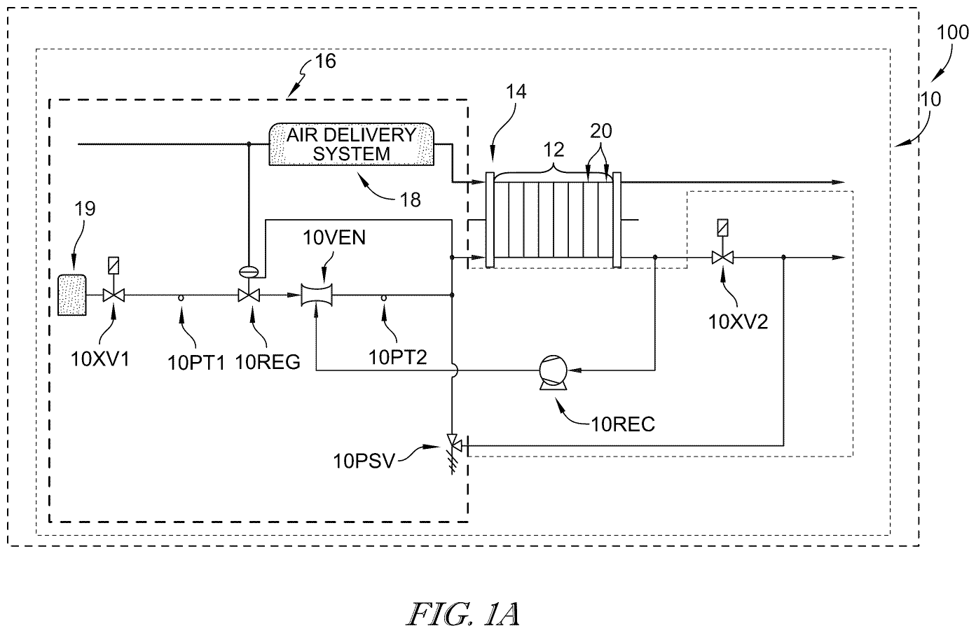

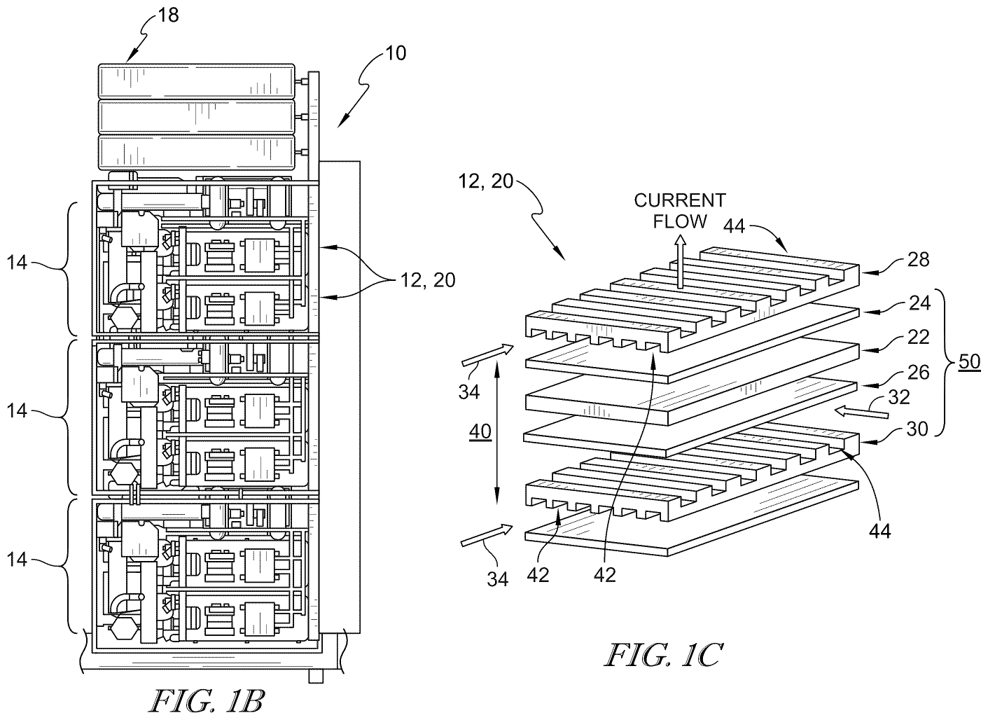

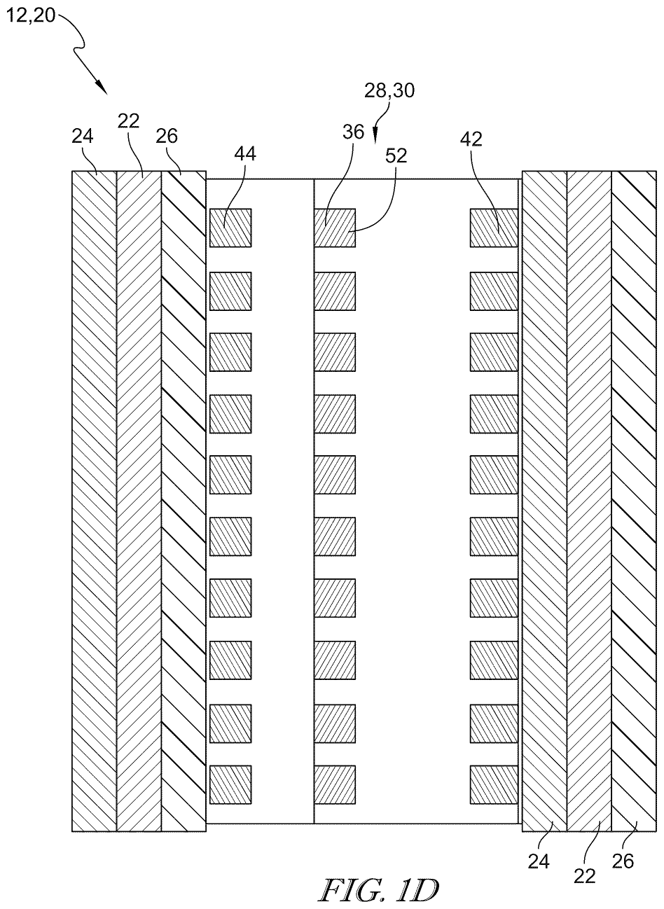

As shown in FIG. 1A, fuel cell systems 10 often include one or more fuel cell stacks 12 (“STK”) or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

In some embodiments, as shown in FIG. 1A, the fuel cell system 10 may include an on/off valve 10XV1, a pressure transducer 10PT1, a mechanical regulator 10REG, and a venturi 10VEN arranged in operable communication with each other and downstream of the hydrogen delivery system and/or source of hydrogen 19. The pressure transducer 10PT1 may be arranged between the on/off valve 10XV1 and the mechanical regulator 10REG. In some embodiments, a proportional control valve may be utilized instead of a mechanical regulator 10REG. In some embodiments, a second pressure transducer 10PT2 is arranged downstream of the venturi 10VEN, which is downstream of the mechanical regulator 10REG.

In some embodiments, the fuel cell system 10 may further include a recirculation pump 10REC downstream of the stack 12 and operably connected to the venturi 10VEN. The fuel cell system 10 may also include a further on/off valve 10XV2 downstream of the stack 12, and a pressure transfer valve 10PSV.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

The present disclosure is directed to systems, assemblies, and methods. In particular, the present disclosure is directed to bipolar plate assemblies 110, 210, 310 and methods which form such assemblies. The bipolar plate assemblies 110, 210, 310 and methods are configured to achieve substantially uniform concentration of oxygen and to manage water concentrations.

In some embodiments described herein, a bipolar plate assembly 110, 210, 310 may include two bipolar sheets sandwiched together. Each sheet has a plurality of elongated lands that are raised away from the sheet to form secondary channels of the assembly 110, 210, 310 and primary channels formed between the elongated lands. The assembly 110, 210, 310 may further include injectors formed as holes in one or more top surfaces of the elongated lands. A first fluid flowing through a secondary channel is forced through an associated injector, subsequently into an adjacent gas diffusion layer, and subsequently into the adjacent primary channel(s). The bipolar plate assemblies 110, 210, 310, also referred to as bipolar plates, according to the present disclosure may be utilized along with or in place of the bipolar plates 28, 30 of the fuel cell system 10 described above.

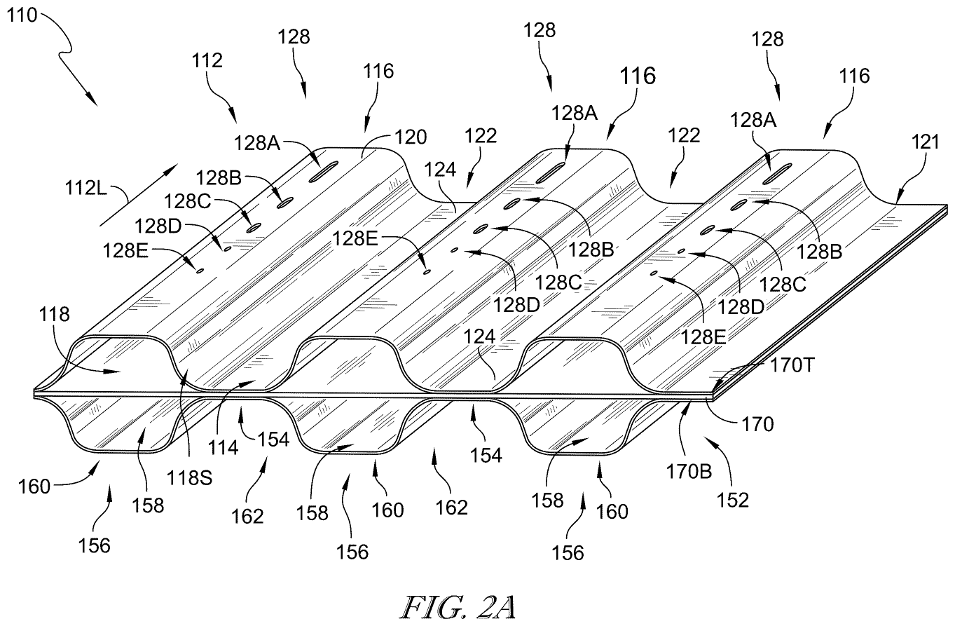

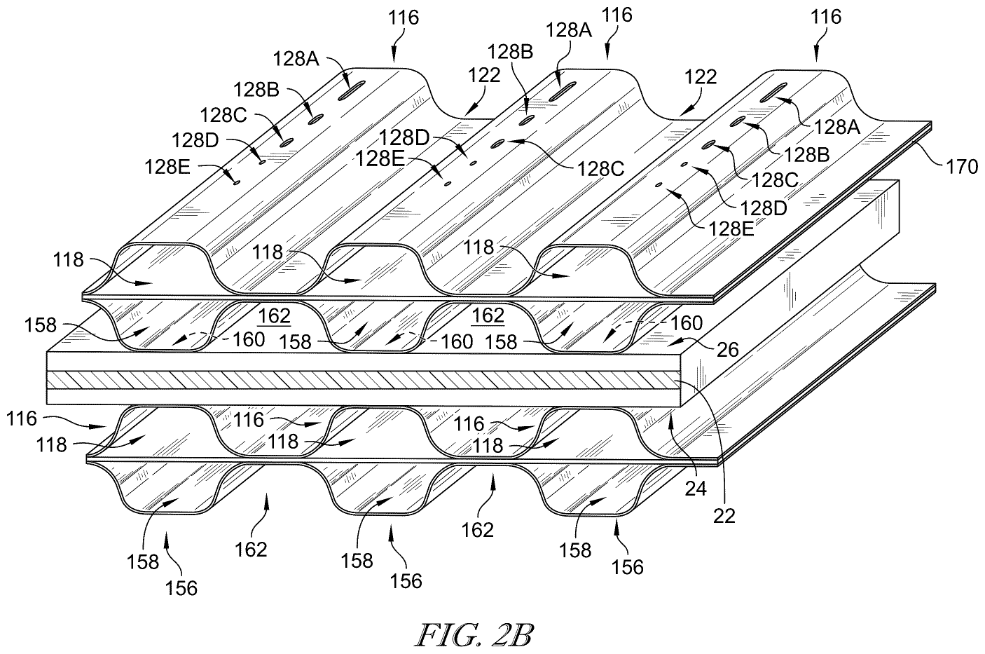

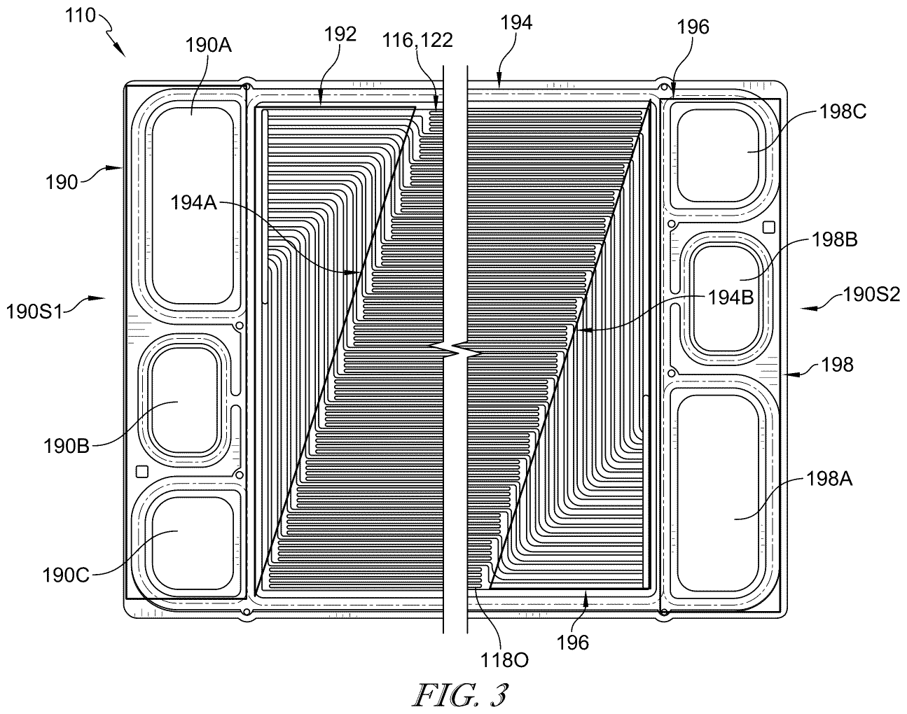

As can be seen in FIGS. 2A and 2B, the bipolar plate assembly 110 includes a first bipolar sheet 112 and a second bipolar sheet 152 sandwiched to each other (e.g., aligned adjacently and/or in parallel). Illustratively, the first bipolar sheet 112 includes a plurality (e.g., one or more, more than one, at least two, more than two, more than three, etc.) of elongated lands 116 extending from a distribution area 192 of the first bipolar sheet 112 to an exhaust area 196 of the first bipolar sheet 112 (see areas 192, 194, 196 in FIG. 3). The plurality of elongated lands 116 are raised away from a first sheet surface 114 of the first bipolar sheet 112. The plurality of elongated lands 116 are formed as hollow channels so as to define first secondary channels 118 therein. Primary channels 122 are formed between the elongated lands 116. The distribution (input) and exhaust (output) areas 192, 196 may also be referred to herein as input and output ends or input and output portions, respectively.

Illustratively, a plurality of injectors 128 (e.g., 128A, 128B, 128C, 128D, 128E, etc.) are formed on a land top surface 120 of the elongated lands 116. A fluid flowing through the elongated lands 116 is forced through the respective injector(s) 128 located on that elongated land 116, subsequently into an adjacent gas diffusion layer 24, and subsequently into the adjacent primary channel 122. Similarly, the second bipolar sheet 152 includes a plurality of elongated lands 156 extending from the distribution area 192 to the exhaust area 196. The plurality of elongated lands 156 are raised away from a second sheet surface 154 of the second bipolar sheet 152, as shown in FIG. 2A. The plurality of elongated lands 156 are formed as hollow channels so as to define second secondary channels 158 therein. Primary channels 162 are formed between the elongated lands 156. A separator plate 170 is arranged between the first and second bipolar sheets 112, 152 and is configured to separate adjacent interior areas of the elongated lands 116, 156.

The bipolar plate assembly 110 may be comprised of a plurality of formed sheets (i.e. sheets 112, 152) of material bonded or welded adjacent to each other. The welding of the sheets 112, 152 together confines water, reactants, and/or fluids therein. In some embodiments, the sheets 112, 152 may be pressed together with the adjacent gas diffusion layer 24, 26 and a seal therebetween to confine the water and/or the reactants. By way of non-limiting examples, the plate assembly 110 may be formed of one, two, three, or more sheets. Illustratively, the bipolar plate assembly 110 is formed of two layered sheets 112, 152.

The material of the sheets 112, 152 may be about 20% to about 100% metal, including any percentage or range of percentages of metal comprised therein to form a metal bipolar plate. Typically, a sheet 112, 152 of a metal bipolar plate assembly 110 may comprise about 50% to about 100% metal, including any percentage or range of percentage of metal comprised therein. An exemplary sheet 112, 152 embodiment of the metal bipolar plate assembly 110 may comprise about 50% to about 100% metal, including any percentage or range of percentage of metal comprised therein. In another embodiment, the sheet 112, 152 of the metal bipolar plate assembly 110 may comprise about 90% to about 100% metal, including any percentage or range of percentage of metal comprised therein.

The metal of the bipolar plate assembly 110 may be any type of electrically conductive metal, including but not limited to, austenitic stainless steel (304L, 316L, 904L, 310S), terrific stainless steel (430, 441, 444, Crofer), Nickel based alloys (200/201, 286, 600, 625), titanium (Grade 1, Grade 2), or aluminum (1000 series, 3000 series). Exemplary metals comprised by the metal bipolar plate assembly 110 may be steel, iron, nickel, aluminum, and/or titanium, or combinations thereof.

The material and structure of the bipolar plate assembly 110 affects the conductivity of the fuel cell 20 or fuel cell stack 12. In some embodiments, the material of the bipolar plate assembly 110 is graphite, a non-metal material. Similarly, the material of the bipolar plate assembly 110 may be any material similar to a powder-based product. For example, the material of the bipolar plate assembly 110 may be prepared by an impregnation and/or a solidifying process, such as a graphite-based powder. Graphite and other such materials of the bipolar plate assembly 110 may not have the capacity to retain the necessary strength or uniformity to support the fuel cell 20 or the fuel cell stack 12 without maintaining a certain minimum width or thickness. However, metal as a material of the bipolar plate assembly 110 has considerably more strength than a non-metal, and therefore, lower limitations.

One or more sheets 112, 152 of the metal bipolar plate assembly 110 are configured to be in contact, to overlap, to be attached, or connected to one another in order to provide the flow fields 42, 44, 52 for the fuel cell fluids 32, 34, 36. The sheets 112, 152 of the metal bipolar plate assembly 110 may be sealed, welded, stamped, structured, bonded, and/or configured in any way to provide the flow fields 42, 44, 52 for the fuel cell fluids 32, 34, 36 (e.g., two, three, or more fluids). Illustratively, the sheets 112, 152 of the metal bipolar plate assembly 110 may be sealed and/or welded together to form the flow fields 42, 44, 52.

In some embodiments, the bipolar plate assembly 110 may be unitized around the MEA 22 and the gas diffusion layers 24, 26 to shift the repeating unit 50. In such embodiments, the repeating component progression of the bipolar plate assembly 110, the MEA 22, and the gas diffusion layers 24, 26, are arranged as described above with regard to bipolar plates 28, 30. However, the individual formed sheets (first and second bipolar sheets 112, 152) are not welded together with the separator plate 170 therebetween. Instead, the first and second bipolar sheets 112, 152 may be glued or bonded to the respective side of the adjacent gas diffusion layer 24, 26 to form a unit cell. The separator plate 170 may be welded to one of the first and second bipolar sheets 112, 152 to form a leak tight seal. When stacking the components together, the separator plate 170 may be pressed against the other of the first and second bipolar sheets 112, 152 with a seal to prevent leakage.

In some embodiments, one or more sheets 112, 152 of the metal bipolar plate assembly 110 may be coated with one or more coatings 121, as shown in FIG. 2A, for corrosion resistance using any method known in the art (e.g., spraying, dipping, drenching, electrochemically bathing, adding heat, etc.). In some embodiments, the coatings 121 may be metal based and include, but not limited to, elements such as zinc, chromium, nickel, gold, platinum, and various alloys or combinations thereof. In other embodiments, the coatings 121 may be a graphite-based coating that protects, reduces, delays, and/or prevents the bipolar plate 110 from corroding (e.g., rusting, deteriorating, etc.). Since graphite substrates resist oxidation, it may be advantageous to coat the metal of the bipolar plate assembly 110 with a graphite-based treatment 121 or coating 121.

As shown in FIG. 3, the bipolar plate assembly 110 includes an inlet manifold region 190, the distribution area 192, an active area 194, the exhaust area 196, and/or an exhaust manifold region 198. The inlet manifold region 190 can include a first manifold 190A (also referred to as a port), a second manifold 190B, and/or a third manifold 190C. Each manifold 190A, 190B, 190C may be formed as a sizable opening located on or towards one side 190S1 of the plate assembly 110. In some embodiments, the manifolds 190A, 190B, 190C are punched through the sheet 112. In some embodiments, the outer contour of each manifold 190A, 190B, 190C may match the contour of the outer edge of the bipolar plate assembly 110 on that side 190S1 of the bipolar plate assembly 110.

Similarly, the bipolar plate assembly 110 may further include a fourth manifold 198A, a fifth manifold 198B, and/or a sixth manifold 198C, as shown in FIG. 3. Each manifold 198A, 198B, 198C may be formed as a sizable opening located on or towards the side 190S2 of the bipolar plate assembly 110 opposite the side 190S1 on which the manifolds 190A, 190B, 190C are formed. In some embodiments, the outer contour of each manifold 198A, 198B, 198C may match the contour of the outer edge of the bipolar plate assembly 110 on that side 190S1, 190S2 of the bipolar plate assembly 110.

In some embodiments, the orientation and/or location of the first, second, and third manifolds 190A, 190B, 190C may be opposite the orientation and/or location of the fourth, fifth, and sixth manifolds, 198A, 198B, 198C. Specifically, as shown in FIG. 3, the location of manifolds 190A, 190B and 190C may be opposite and/or reversed the location of manifolds 198A, 198B, and 198C, respectively. Similarly, as shown in FIG. 3, the orientation of manifolds 190A, 190B and 190C may be opposite and/or reversed the location of manifolds 198A, 198B, and 198C, respectively. This sort of orientation and location arrangement of the manifolds helps deliver more consistent water, reactant, and/or fluid movement throughout the bipolar plate assembly 110.

Some embodiments of the bipolar plate assembly 110 may comprise more or less than six manifolds. For example, the bipolar plate assembly 110 may comprise a number of manifolds ranging from about 2 to about 50 manifolds, including any specific number or range of manifolds comprised therein. In illustrative embodiments, the bipolar plate assembly 110 will be configured to have an even number of manifolds in order to have the same number of manifolds on each side of the bipolar plate assembly 110.

In an exemplary embodiment, a PEM fuel cell 20 that is supplied with atmospheric air is subject to the following chemical equation (Equation 1) on the cathode side 24 of the MEA 22:

$$2 {H}_{2} + {λ}_{ca} ( {O}_{2} + ( \frac{1}{{C}_{{O}_{2}}} - 1 ) {N}_{2} ↔ 2 {H}_{2} O + ( {λ}_{ca} - 1 ) {O}_{2} + {λ}_{ca} ( \frac{1}{{C}_{{O}_{2}}} - 1 ) {N}_{2} \qquad ( 1 )$$

Lambda (λ) in Equation 1 is the excess cathode air ratio multiplier (also known as an excess stoichiometric ratio or stoich). C in Equation 1 is the dry air oxygen mole fraction in the atmosphere (or supply system, approximately 0.21 for the atmospheric air). The sole product of the reaction is water, and the remaining chemical species consist of the nitrogen spectator ion (if C<1.0) and the remaining oxygen (if lambda>1.0).

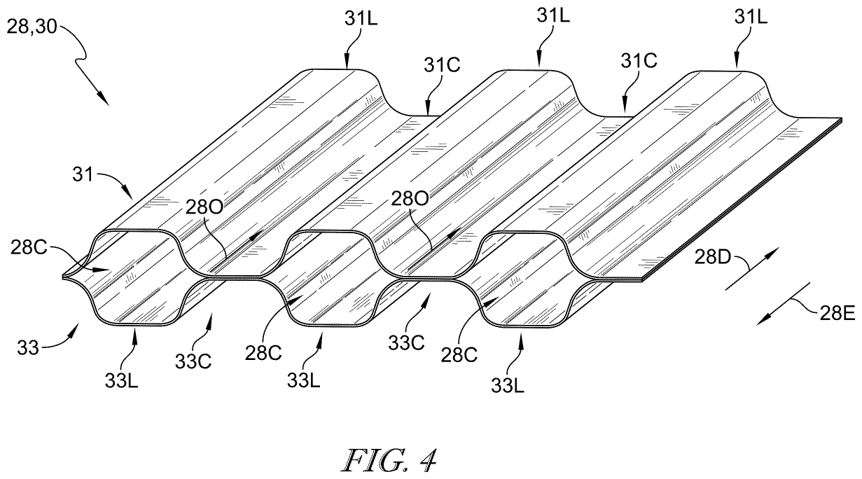

Equation 1 may hold true for inlet and outlet conditions of the fuel cell 20, in particular at the manifolds 190A, 190B, 190C, 198A, 198B, 198C. There may be spatially dependent changes that occur along the channels (i.e., the primary channels 122, 162 of the bipolar plate assembly 110 or channels 31C, 33C as shown in FIG. 4) as electrical generation, and subsequently reactant 32, 34 consumption, take place. As the inlet air travels over the length of the channel 122, 162 there are two changes to the constituents and/or reactants 32, 34.

Firstly, the oxygen content decreases as the molar consumption supports electrical generation. Secondly, as a direct result of oxygen consumption, there is an increase in water content. The total count of oxygen atoms is retained on the cathode side (gas diffusion layer 24, also referred to as a cathode 24, as shown in FIG. 2B) as the reaction converts oxygen to water with the addition of hydrogen molecules, and as the oxygen atoms permeate into the cathode stream from the anode side (gas diffusion layer 26, also referred to as an anode 26, as shown in FIG. 2B) of the MEA 22.

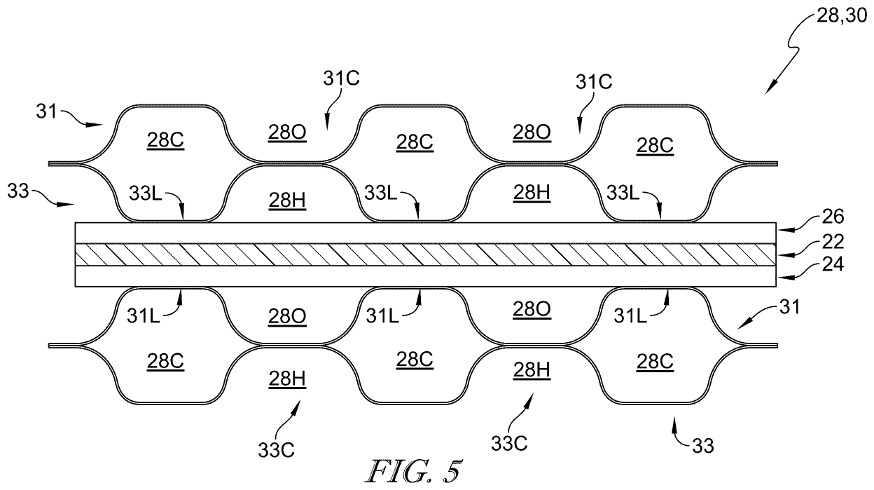

A typical bipolar plate assembly 28, 30, in which the above described process may occur, is shown in FIGS. 4 and 5. The bipolar plate assembly 28, 30 includes a top sheet 31 and a bottom sheet 33 sandwiched together. The top sheet 31 includes elongated lands 31L formed thereon and channels 31C formed therebetween through which oxygen 28O may flow.

The bottom sheet 33 includes elongated lands 33L formed thereon and channels 33C formed therebetween through which hydrogen 28H may flow. Elongated secondary channels 28C are formed between the elongated lands 31L, 33L. The top sheet 31 may be formed as a cathode formed plate and the bottom sheet 33 may be formed as an anode formed plate.

Coolant 36 may run through the elongated secondary channels 28C. Typically, the coolant 36 and the cathode reactant 28O (e.g., air/oxygen/oxidant) are operated in the same direction (direction 28D). The anode reactant 28H (e.g., hydrogen/fuel) can be in a co-flow direction (i.e., same direction) or a counter-flow direction (i.e., opposite direction) to the coolant 36 and the cathode reactant 28O (i.e. in direction 28D or 28E).

Gas diffusion layers 24, 26 may be sandwiched between two bipolar plate assemblies 28, 30, as shown in FIG. 5. FIG. 5 also shows the fluidic domains of the fluids 280, 28H, 36, and how the channels 31C, 33C, 28C in which the fluids 28O, 28H, 36 flow would be assembled around a single fuel cell section (i.e., the gas diffusion layers 24, 26 and the MEA assembly 22). The overlapping channels 31C, 33C produce the supply for the anode 26 and cathode 24. The contacting lands 31L, 33L enable conduction for the coolant 36 flowing through secondary channels 28C to regulate the temperature of the gas diffusion layers 24, 26 and the MEA 22 assembly.

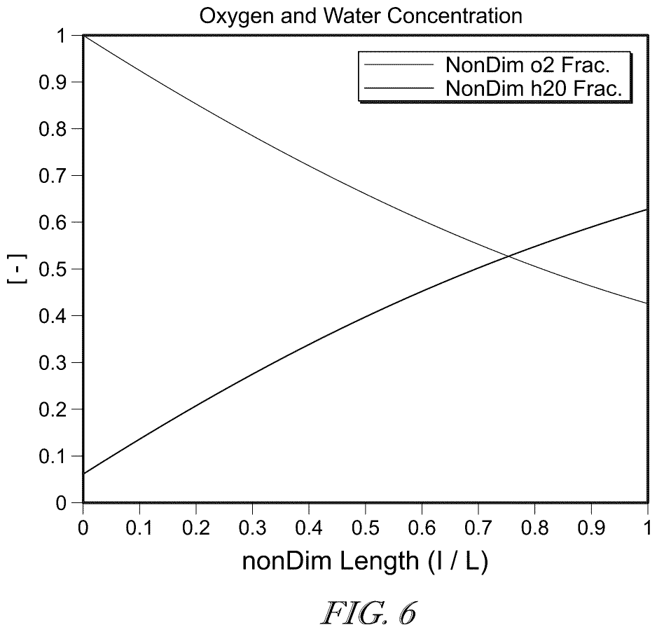

An example of how the concentration gradient within a cathode channel 122 (or the channels 31C) may change is shown in FIG. 6. The graph of FIG. 6 shows that the oxygen 28O concentration and the water concentration gradients are equal and opposite. The graph is plotted non-dimensionally, with the channel inlet at 0 and the channel exit or outlet at 1. The inlet oxygen 28O concentration is initially at 1 and lowers in accordance with the molar balance with an excess air ratio stoich of 1.8 and a supply concentration (C) of 0.21. The water concentration raises proportionally to the drop in oxygen 28O. There is a non-zero value for water, as the ambient conditions were at 50% relative humidification (RH) and 25° C.

A person skilled in the art will understand that most of the fuel cell 20 performance spatial variations are a direct result of the cathode 24 constituent or reactant 28O concentration. In general, the higher the concentration available at the reaction site, i.e., the cathode side 24, the better the fuel cell 20 will perform.

For example, there are two methods to increase the oxygen 28O content available at the inlet of the channel 122, 31C. Firstly, by increasing the pressure. Secondly by changing the oxygen to nitrogen (O₂:N₂) ratio and/or the supply concentration (C).

Increasing the pressure should be considered sparingly, due to the parasitic losses associated with the thermodynamic requirement at the air system level. The compressor power required to operate at elevated pressures is considerably more than at lower pressures. Increasing pressure will directly affect the net output of the fuel cell system 10 as the compressor parasitic power is subsidized from the fuel cell stack 12 power. This power consideration may be important in applications such as e-mobility, where net power and fuel consumption is important due to a finite onboard fuel capacity.

Additionally, pressure changes the saturation characteristics of the fuel cell 20 and may prematurely cause condensation if increased too much. Increasing the air concentration by elevating the ratio of oxygen to nitrogen (O₂:N₂) may require an oxygen bulk supply tank, which may not be preferable in e-mobility applications.

As the reactant (i.e., oxygen 28O) travels down the length of the channel 122, 31C (from the inlet toward the outlet), the concentration lessens as the oxygen molecules are exchanged with water to support the reaction of the adjacent MEA 22. The stoich may be increased to lessen the concentration gradient, but an increase in stoich is a direct parasitic multiplier for the air system. For example, a stoich of 3.0 is 1.5 times more parasitic for the air system than operating at a stoich of 2.0 (Sample calculation; (3.0/2.0)=1.5). Due to the direct parasitic multiplier, it is difficult to justify a stoich value far beyond 2.0. The same is true for comparatively lower stoichs.

If a fuel cell 20 is operated at a stoich of 1.5 to lessen the parasitic values, the parasitic values would be lowered by 33%. However, a bipolar plate (BPP) design more robust to high concentration gradients would be required. In the case of the stoich of 2.0, with an inlet oxygen concentration of 21%, the outlet oxygen concentration is expected to be about 10.5%. In the case of the stoich of 1.5, with an inlet oxygen concentration of 21%, the outlet oxygen concentration is expected to be 7%.

High oxygen concentration changes, caused by large oxygen gradients, can have adverse spatial effects with regards to the fuel cell 20 active area 194. High relative inlet oxygen concentrations may produce excessively high local currents because of the abundance of oxygen. High local currents may cause excessive local heat generation or “hot spots,” which can result in a variety of issues, such as aggressive local aging of the MEA 22, the gas diffusion layers 24, 26, and/or corrosion of the bipolar plate assembly 110 substrate (this latter effect is specific to metal substrates). Low exit concentrations of oxygen may cause excessive performance losses and make for an ineffective fuel cell 20. Both issues may become problematic at high currents when there is an excessive oxygen concentration gradient, which may be further exacerbated by comparatively low excess stoichiometric ratios if any limits exist in either fuel or air handling system.

Water concentration can also be seen to increase congruently to the oxygen constituent. In theory, the higher the relative humidity or humidification (RH), the more performance one can expect from a fuel cell 20. However, careful consideration may need to be exercised during operation of the fuel cell 20 not to increase humidity levels too drastically. If the humidity increase along the channel 122, 31C causes premature condensation, then excessive flooding may take place further downstream in the channel 122, 31C. Often, the thermodynamic conditions at the point of maximum performance are found to be at or near the conditions that produce a relative humidity of 99% at the cathode 24 outlet. A high range from 80% to 99% relative humidity, including any specific or range of relative humidity comprised therein, is reasonable to target at the cathode 24 outlet, which is where the stoich, temperature, and/or pressure are near the point of liquid water formation.

Conversely, too little water concentration, which normally takes place towards the active area inlet side 194A, before increasing downstream, can cause local drying of the MEA 22. Local drying of the MEA 22 may lessen an ability of the MEA 22 to efficiently transport the hydrogen protons through the membrane, which subsequently causes performance losses. Thus, an effective fuel cell 20 must be robust to excessive water generation and be able to operate effectively under aggressive and/or high humidity conditions.

Liquid water may form within the fuel cell 20 toward the latter portions of the flow channels 122, 162, 31C, 33C due to several reasons. Firstly, there may be an increased relative humidity past the point of saturation due to the water generation and oxygen consumption. Secondly, there may be transient events during fuel cell 20 operation that momentarily produce excessive water generation before the fuel cell stack 12 and the fuel cell system 10 components are able to react. The lagging may cause a momentary rate mismatch between the water generation, through increase in current demand and the mechanisms that promote advection, mostly attributed to reactant 32, 34 flow and temperature regulation.

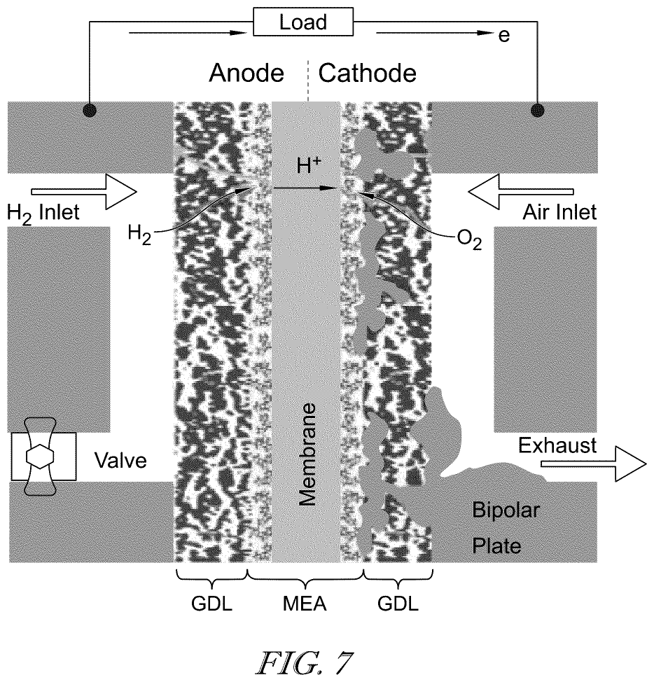

FIG. 7 shows a schematic of a simplified unit cell (i.e., single repeating unit 50). FIG. 7 illustrates a primary path-length of the bipolar plate 28, 30, 110 and the gas diffusion layer 24, 26 and the MEA 22 assembly. The gas diffusion layer 24, 26 has several functional requirements.

Firstly, the gas diffusion layer 24, 26 must be electrically and thermally conductive to enable electrical continuity and heat transfer from the electrode (comprising the MEA 22) to the bipolar plate 28, 30, 110. Secondly, the gas diffusion layer 26 must enable oxygen diffusion from the channel 162, 33C of the bipolar plate 28, 30, 110 to the reaction site, i.e., the cathode side 24. Lastly, the gas diffusion layer 24, 26 must buffer the water retention capacity of the fuel cell 20 so that the gas diffusion layer 24, 26 helps to retain a portion of the product water within pores of the MEA 22. The second and third gas diffusion layer 24, 26 functional requirements, such as enabling oxygen diffusivity and water buffering, produce competing effects. Thus, gas diffusion layer 24, 26 selection is important for the intended application.

The fuel cell 20 thermodynamic conditions, such as pressure, temperature, and/or stoich, can be varied to help reduce flooding over the entire active area 40, 194 of the bipolar plate 28, 30, 110. For example, increasing temperature, increasing stoich, and/or decreasing pressure result in thermodynamic conditions that are more favorable for product water to form in the gaseous state. The opposite effects of decreasing temperature, decreasing stoich, and/or increasing pressure result in thermodynamic conditions that are more favorable for product water to form in the liquid state.

The issue with relying on thermodynamics alone to optimize the local water conditions within the fuel cell 20 is that the change in the water content from the inlet to the outlet are drastically different. The change can be seen in FIG. 6, where the water content increases more than 6 times the initial value, and may be reduced to 2 times depending on the required inlet humidity conditions. Nevertheless, while the partial pressure of water increases, the thermodynamic conditions do not vary within the active area 40, 194 to such a degree. As a result, the typical approach with respect to thermodynamics is to find set points that result in the best average performance over the entire active area 40, 194.

Often, the thermodynamic conditions at the point of maximum performance are found to be at or near the conditions that produce a relative humidity of 99% at the cathode 24 outlet. A high range from 80% to 99% relative humidity, including any specific or range of relative humidity comprised therein, is reasonable to target at the cathode 24 outlet, which is where the stoich, temperature, and/or pressure are near the point of liquid water formation. Any further formation of water is likely to cause fuel cell 20 conditions that begin to exhibit flooding symptoms within the gas diffusion layer 24, 26. Any less relative humidity (RH) than about 80%, and the fuel cell 20 is likely to exhibit a reduction of performance due to a lack in proton conductivity (explained briefly above, in particular, that the preference for relative humidity (RH) is high). High humidity helps to improve the proton permeation, and thus the ability of the membrane to allow hydrogen to pass through it. However, as the relative humidity increases beyond 99%, the gas diffusion layer 24, 26 may start to become blocked (e.g., flooded) with liquid water.

Blockage of the gas diffusion layer 24, 26 with liquid water reduces the capacity of oxygen to be transferred from the bipolar plate 28, 30, 110, through the gas diffusion layer 24, 26, and reach the catalyst layer of the MEA 22. Thus, with typical bipolar plate 28, 30, 110 flow fields, the relative humidity curve is likely constrained to an outlet boundary nearing condensation, which is greater than about 99% relative humidity. Any excess relative humidity (RH) may cause liquid water formation, which is likely to result in local flooding.

In one example, the inlet to outlet is scaled by a factor of 6 (i.e. 0.1 to 0.6 concentration), as depicted in FIG. 6. If the outlet of the bipolar plate 28, 30, 110 is operating at a RH of 99%, then the inlet RH must be at approximately 16%. The RH along the channel 122, 162, 31C, 33C would increase from 16% to 99% from 0 to 1 along the x-axis (non-dimensional length of the channel 122, 162, 31C, 33C), as shown in FIG. 6. However, the MEA 22 performance from the inlet to the outlet would have been better if the inlet humidity was higher than 16%, in particular 20% or 25%. The issue with setting the thermodynamics to compliment 25% RH at the inlet is that the outlet would then be at 150% RH (6×25%=150%), and thus ⅓^{rd} of the product water would be in the liquid state. This result, although better for the inlet and middle portions of the fuel cell 20, would likely not be attainable at the outlet. Excessive liquid formation and blockage of the gas diffusion layer 24, 26 can cause aggressive adverse fuel cell 20 effects that may cause instabilities and potentially put the outlet in a state of near-term catastrophic failure.

The disclosed bipolar plate assemblies 110 are designed to forcefully overcome gas diffusion layer 24, 26 flooding. Due to physical obligations in fuel cells 20, there will be a gradient of oxygen and water along the channel 122, 162, 31C, 33C. The gradient will cause local performance differences that sum up to the total performance of the bipolar plate 28, 30, 110 and subsequently the fuel cell stack 12. Thus, the full-scale fuel cell stack 12 is designed in a way that compliments the local conditions of the fuel cell 20, while maintaining the total best-case performance scenario along the entire flow channel 122, 162, 31C, 33C.

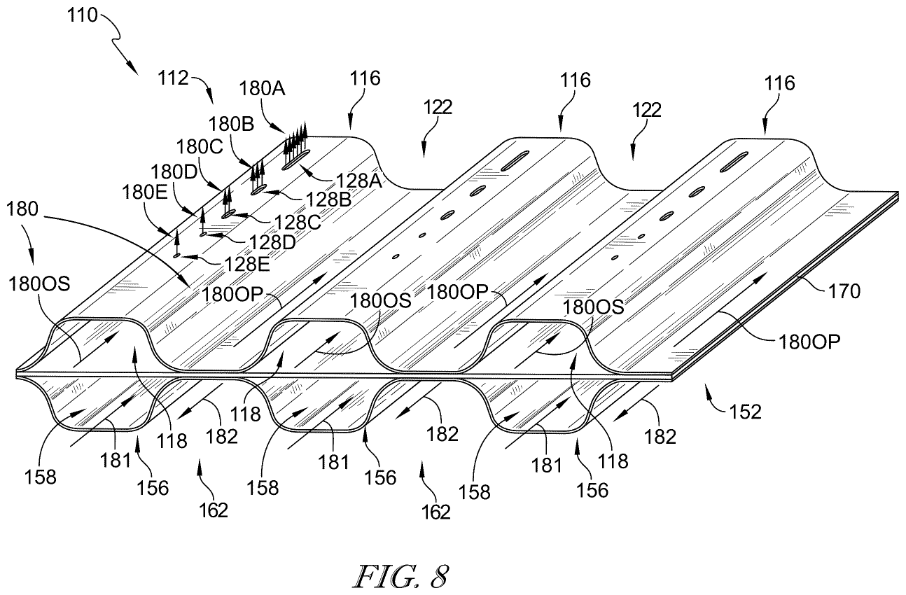

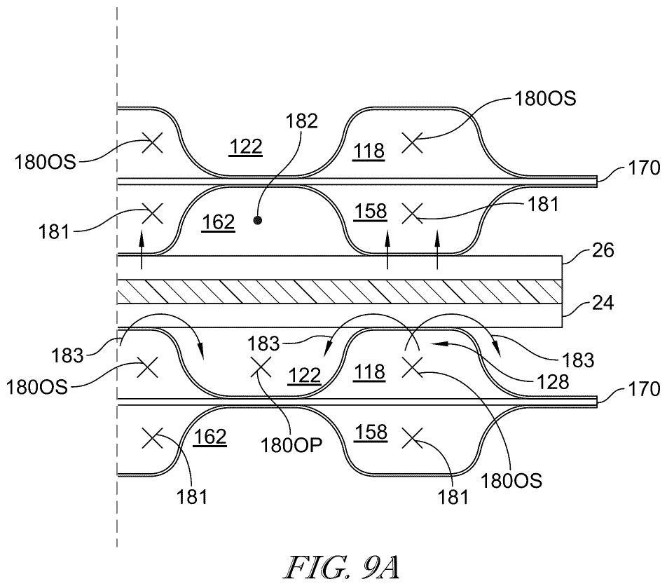

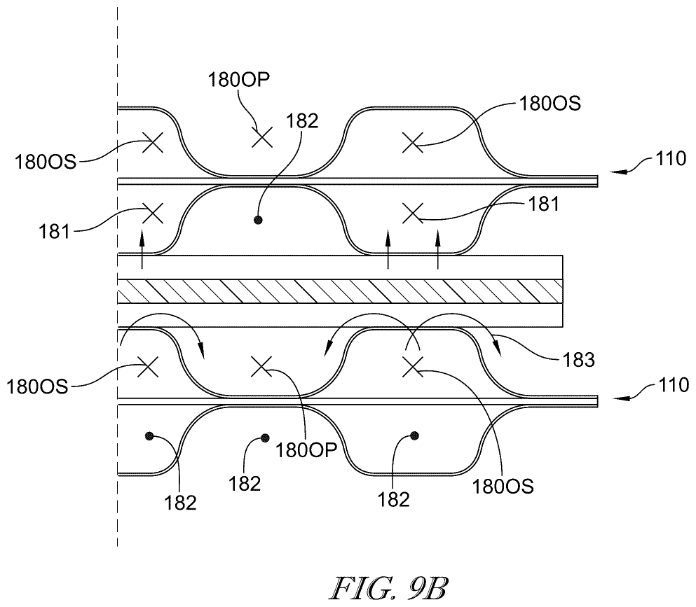

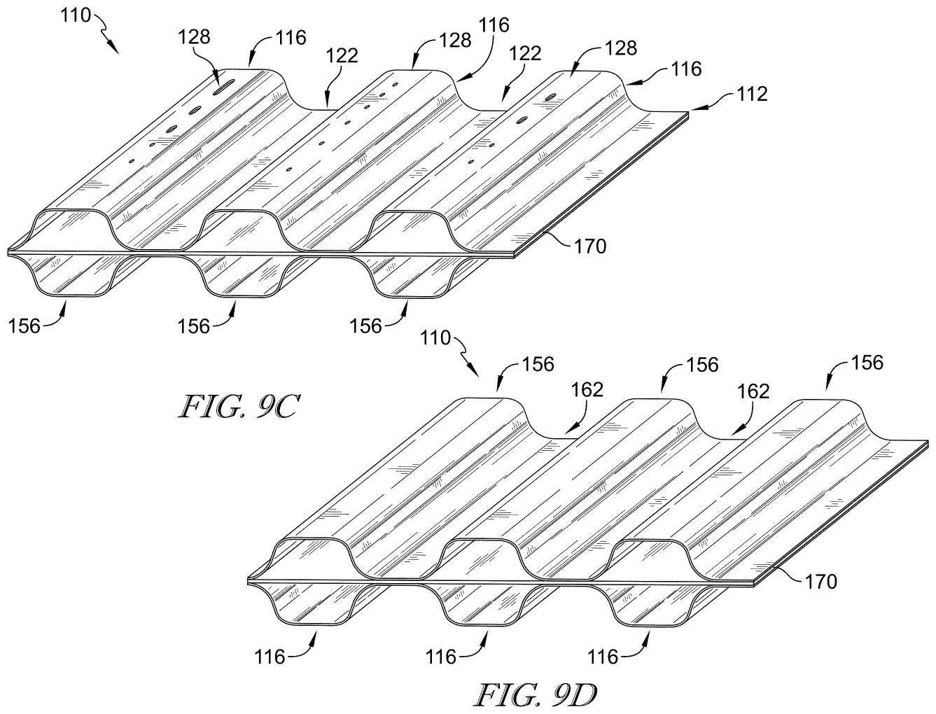

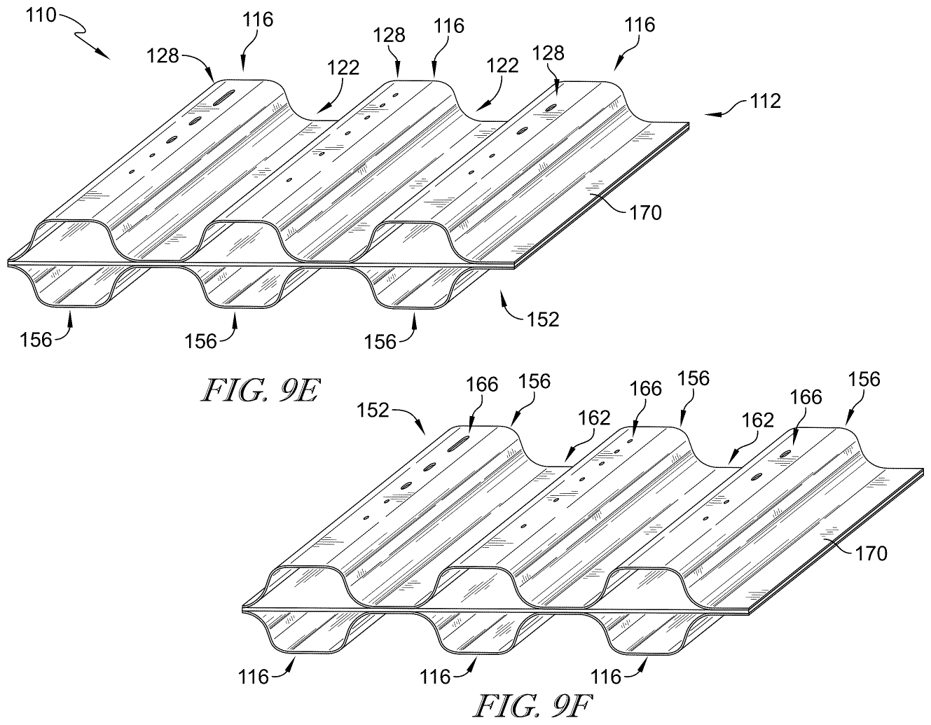

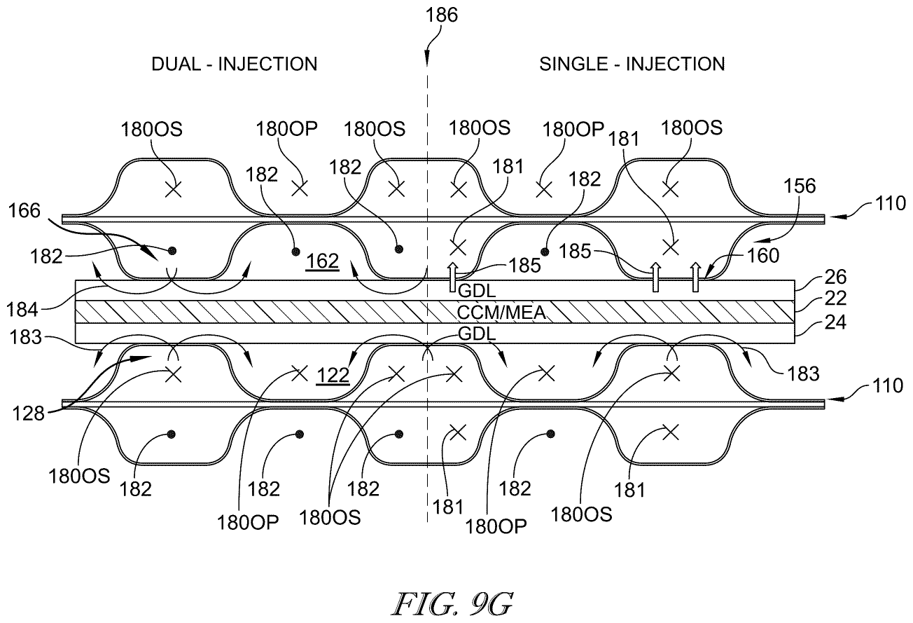

FIGS. 2A, 2B, 8, 9A, and 9B illustrate the bipolar plate assembly 110 according to the present disclosure. As can be seen in greater detail in FIGS. 8, 9A, and 9B, the separator plate 170 creates isolation of a portion of the coolant fluid domain (see 28C in FIG. 4). The isolation of the coolant fluid domain by the separator plate 170 separates the coolant secondary channel 28C into two channels, in particular secondary channels 118, 158, formed in adjacent lands 116, 156. The secondary channel 118 may be referred to as a first secondary channel 118, and the secondary channel 158 may be referred to as a second secondary channel 158. As such, the once combined coolant fluid domain can be used for both a reactant 32, 34 of choice or a coolant 36 of choice.

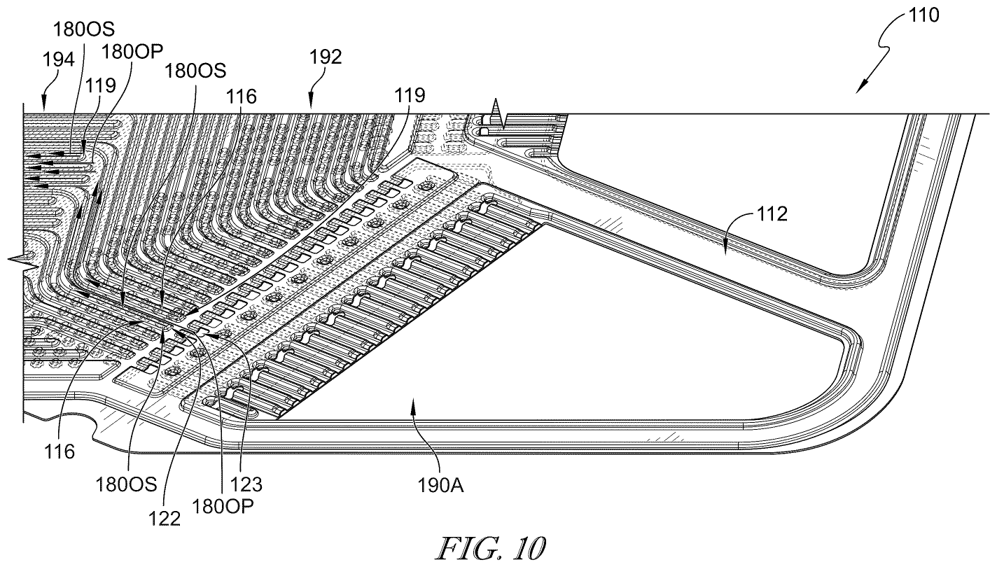

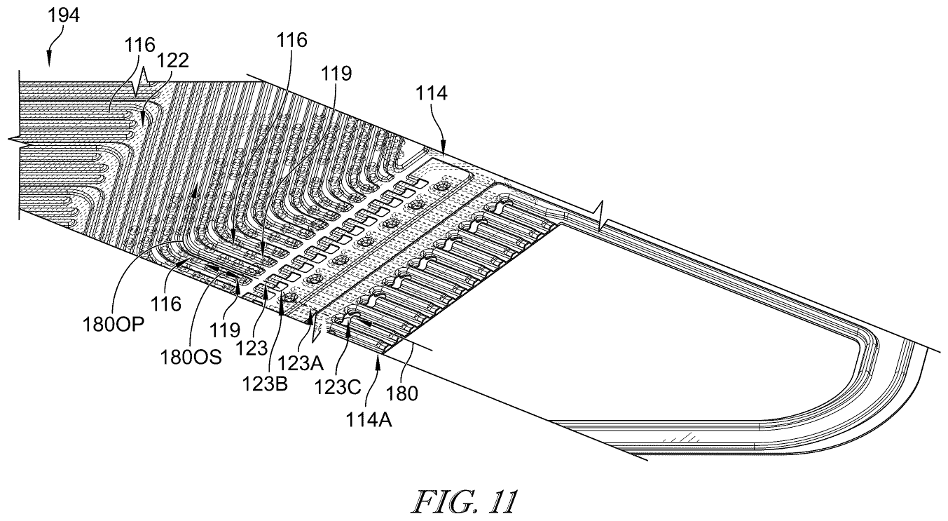

As shown in FIGS. 10 and 11, the elongated lands 116 may extend from the inlet manifold region 190, and in particular, from the first manifold 190A, through the distribution area 192, and then into the active area 194. In some embodiments, the elongated lands 116 may extend parallel with each other throughout the entirety of the longitudinal extent of the elongated lands 116. The plurality of elongated lands 116 may each include the land top surface 120, as shown in FIG. 2A.

The first bipolar sheet 112 further includes primary channels 122 formed between each of the elongated lands 116, as shown in FIGS. 2A, 2B, 8, 9A, and 9B. The primary channels 122 are defined by outer surfaces 118S of two adjacent elongated lands 116, as shown in FIG. 2A. Each primary channel 122 includes a channel bottom surface 124, which may also be the first sheet surface 114 of the first bipolar sheet 112. In some embodiments, the channel bottom surfaces 124 are generally parallel with the land top surfaces 120.

At least some of the land top surfaces 120 include at least one injector 128 as shown in FIGS. 2A and 8. The at least one injector 128 is formed as a hole in the land top surface 120 and located in the active area 194 of the first bipolar sheet 112, as shown in FIGS. 2A and 8. Although in some embodiments the elongated lands 116 may include single injectors 128 at certain positions along the longitudinal length of the elongated lands 116, illustratively, the elongated lands 116 include groups of injectors 128, also referred to as a plurality of injectors 128 herein.

The elongated lands 116 may include multiple groups of injectors 128 arranged along the length of the elongated land 116, as will be described in greater detail below. In some embodiments, injectors 128 are not included on every elongated land 116, but only on select elongated lands 116, such as every other elongated land 116, every third elongated land 116, every fourth elongated land 116, or any other combination understood by a person skilled in the art. In further embodiments, the remaining first secondary channels 118 may have thermal standoffs (not shown) or additional features to compliment the absence of injectors 128.

In at least some embodiments, the elongated lands 116 may include at least one of the plurality of injectors 128 formed thereon. By way of a non-limiting example, as shown in FIGS. 2A and 8, the elongated lands 116 may include five injectors 128A, 128B, 128C, 128D, 128E per group of injectors 128 arranged proximate to each other, although a person skilled in the art will understand that any number of injectors 128 may be utilized in a particular group of injectors 128. The injectors 128 may be rectangular, as shown in FIGS. 2A and 8, but in some embodiments, the injectors 128 may be circular, triangular, or any other shape, as well as any combination of shapes, that would be effective as understood by a person skilled in the art.

By way of a non-limiting example, a combination that was found to be effective includes a combination of circles toward the inlet side of the elongated lands 116 and elongated rectangles toward the exhaust side of the elongated lands 116, as shown in FIGS. 2B and 9C. A combination of alternating between only circles and the circle to rectangle combination between elongated lands 116, as shown in FIG. 9C is also proven to be effective.

In some embodiments, each injector 128 of the group of injectors 128 is spaced apart from each other, as shown in FIGS. 2A and 8. In some embodiments, a length of each injector 128 of the group of injectors 128 as measured in the longitudinal direction 112L of the elongated lands 116 increases for each successive injector 128 along the longitudinal direction 112L. In some embodiments, each injector 128 has an equal length. In some embodiments, the length of each injector 128 may decrease for each successive injector 128 along the longitudinal direction 112L.

The injectors 128 are provided such that a fluid 180 flowing through the first secondary channel 118 of the elongated land 116 is forced through the injector 128 or injectors 128, subsequently into the adjacent gas diffusion layer 24, and subsequently into the primary channel 122, as shown in detail in FIGS. 2A, 8, 9A, and 9B. As described above, the separator plate 170 separates the secondary channels 118, 158 formed in adjacent elongated lands 116, 156 such that the once full coolant fluid domain (see 28C in FIGS. 4 and 5) is split into two secondary channels 118, 158.

The first secondary channel 118 is selectively sealed off from the corresponding second secondary channel 158. In some embodiments, less than an entirety of the first secondary channel 118 is sealed off from the corresponding second secondary channel 158 such that fluid may be exchanged between the secondary channels 118, 158. As such, the first secondary channel 118 is defined between a top surface 170T of the separator plate 170 and an inner surface of the elongated land 116. A fluidic path of the first secondary channel 118 can be used for either reactant 32, 34 (oxygen or hydrogen), although in the exemplary embodiment, oxygen (or air) 180OS is flowing through the first secondary channels 118 of the first bipolar sheet 112.

The oxygen side of the MEA 22 (i.e., the cathode 24 or the gas diffusion layer 24) is widely accepted to be the rate limiting step in any electrochemical reaction. It is also considered the rate limiting factor for diffusivity when contrasting air 34 with hydrogen 32 through the gas diffusion layers 24, 26. The location and opening area of the injectors 128 is an optimization parameter of any bipolar plate assembly 110.

In particular, as shown in FIG. 9A, the oxygen 180OS first flows (see flow direction 183) through the first secondary channel 118 defined between the elongated land 116 and the separator plate 170. The oxygen 180OS then flows through the adjacent gas diffusion layer 24 (or gas diffusion layer 26 in an embodiment in which the fluid flowing therethrough is hydrogen 32) and into the primary channel 122. The flow direction 183 increases uniformity of a concentration of oxygen 180OS between the distribution area 192 and the exhaust area 196. In the illustrated embodiment, the oxygen 180OS flow through the first secondary channel 118 is broken into five portions 180A, 180B, 180C, 180D, 180E that flow through respective injectors 128A, 128B, 128C, 128D, 128E of the first group of injectors 128, as shown in FIG. 8. As shown in FIG. 9A and indicated by flow direction 183, the first secondary channels 118 with oxygen 180OS flowing therethrough are configured to inject the oxygen 1800S through the injectors 128, through the adjacent gas diffusion layer 24, and into the primary channel 122 to join oxygen 180OP already flowing therein or to start a flow of oxygen 180OP therein. Coolant 181 may flow through the second secondary channels 158 so as to cool the adjacent gas diffusion layer 26 as well as the MEA 22 and the other gas diffusion layer 24. Hydrogen 182 may flow through the primary channel 162 of the second bipolar sheet 152 so as to electrochemically interact with the adjacent gas diffusion layer 26.

In some embodiments, an input end 119 of the elongated lands 116 is located in the distribution area 192, as shown in FIGS. 10 and 11. In some embodiments, the input end 119 may be located at the beginning of the active area 194, as also shown in FIG. 10. A person skilled in the art will understand that any combination of locations of input ends 119 may be utilized based on design requirements of the bipolar plate assembly 110. Illustratively, the input end 119 is open so as to allow input of the fluid 180, in particular oxygen (or air) 1800S in the illustrated embodiment, into the first secondary channel 118 of the elongated land 116. In some embodiments, the input ends 119 are formed by piercing an end of the elongated land 116 in the distribution area 192 or at the beginning of the active area 194.

Similarly, an input end 123 of each primary channel 122 may be located on a side of the distribution area 192 located closest to the first manifold 190A of the inlet manifold region 190, as shown in FIGS. 10 and 11. The input end 123 receives input of the fluid 180, in particular oxygen (or air) 180OP in the illustrated embodiment, from the inlet manifold region 190, as shown in FIG. 11. In some embodiments, the input end 123 may be fluidically connected to an inlet channel 123A upstream of the input end 123. The inlet channel 123A can extend on the opposite surface 114A of the first sheet surface 114 of the first bipolar sheet 112 and fluidically connect to the first sheet surface 114 via holes 123B, 123C, as shown in FIG. 11.

In some embodiments, the primary channel 122 may furcate when it reaches the active area 194 into multiple channels 122 separated by multiple elongated lands 116, as shown in FIGS. 10 and 11. The input end 123 of the first primary channel 122 is open so as to allow additional input of the fluid 180 or oxygen 180 into the first primary channel 122.

In some embodiments, the first bipolar sheet 112 includes a total flow of fluid 180, or oxygen (or air) 180 in the illustrated embodiment, flowing through the first sheet primary channels 122 and first secondary channels 118. In some embodiments the total flow of oxygen (or air) 180 may be split between the primary and secondary channels 122, 118. In other words, a portion 180OS of the total flow of oxygen (or air) 180 enters the input end 119 of the first secondary channels 118 and a remaining portion 180OP enters the input end 123 of the primary channels 122.

In some embodiments, a first percentage of the total flow of the oxygen (or air) 180 is input through the input end 123 of the first primary channel 122. Additionally, a remaining percentage of the total flow of oxygen (or air) 180 is input through the input end 119 of the first secondary channel 118 of the elongated lands 116. A remaining percentage of the total flow of oxygen (or air) 180 is defined as 100% minus the first percentage of the total flow of oxygen (or air) 180.

In some embodiments, the first percentage of the total flow of oxygen (or air) 180 is in a range of 1% to 99%, including any percentage or range of percentages comprised therein. In some embodiments, the first percentage is in a range of 10% to 90%, including any percentage or range of percentages comprised therein. In some embodiments, the first percentage is in a range of 20% to 80%, including any percentage or range of percentages comprised therein. In some embodiments, the first percentage is in a range of 30% to 70%, including any percentage or range of percentages comprised therein. In some embodiments, the first percentage is in a range of 40% to 60%, including any percentage or range of percentages comprised therein. In some embodiments, the first percentage is approximately 50%. In some embodiments, the first percentage is exactly 50%. In some embodiments, the first percentage is exactly 0%. In all such embodiments, the remaining percentage of the total flow of oxygen (or air) is determined as described above.

As shown in FIGS. 10 and 11, the elongated lands 156 may extend from the inlet manifold region 190, and in particular, from the first manifold 190A, through the distribution area 192, and into the active area 194. In some embodiments, the elongated lands 156 may extend parallel with each other throughout the entirety of the longitudinal extent of the elongated lands 156. The plurality of elongated lands 156 may each include a land top surface 160, as shown in FIG. 2A. In some embodiments, the elongated lands 156 are aligned with the elongated lands 116 formed on the first sheet 112 along an entirety of the length of the elongated lands 156. In some embodiments, the elongated lands 156 are sinusoidal such that only a portion of the elongated lands 156 are aligned with the elongated lands 116 along the length of the elongated lands 156.

The primary channels 162 of the second bipolar sheet 152 are defined by outer surfaces of two adjacent elongated lands 156. Each of the primary channels 162 includes a channel bottom surface 164, which may also be the second sheet surface 154 of the second sheet 152. In some embodiments, the channel bottom surfaces 164 are generally parallel with the land top surfaces 160.

Illustratively, the second secondary channels 158 are each defined between an elongated land 156 and a bottom surface 170B of the separator plate 170. A second fluid 181 flows through the second secondary channels 158. The second fluid 181 is different than the first fluid 180. In some embodiments, as shown in FIG. 9A, the first fluid 180 is oxygen (or air) and the second fluid 181 is coolant. In some embodiments, a third fluid 182 flows through the primary channels 162 formed on the second sheet 152. The third fluid 182 is different than the first and second fluids 180, 181. In some embodiments, the third fluid 182 is hydrogen, which may interact with the adjacent gas diffusion layer 26, as shown in FIG. 9A.

In some embodiments, an output end 118O of the first secondary channel 118 of the first bipolar sheet 112 is located in the exhaust area 196 of the first bipolar sheet 112, as shown in FIG. 3. In particular, the output end 118O may be closed in some embodiments so as to cause a pressure drop in the fluid 180 flowing through the first secondary channel 118. The pressure drop forces the fluid 180 to flow through the injectors 128.

A person skilled in the art will understand that the arrangement and geometry of the injectors 128 may be tailored based on the design requirements of the bipolar plate assembly 110. For example, an injector 128 area (i.e., an area occupied by a group of injectors 128) or frequency of groups of injectors 128 along the length of the elongated lands 116 may increase towards the end of the elongated land 116. This is due to the increased likelihood that the liquid water will begin to accumulate towards the latter sections of the active area 194, especially toward the exhaust side 194B.

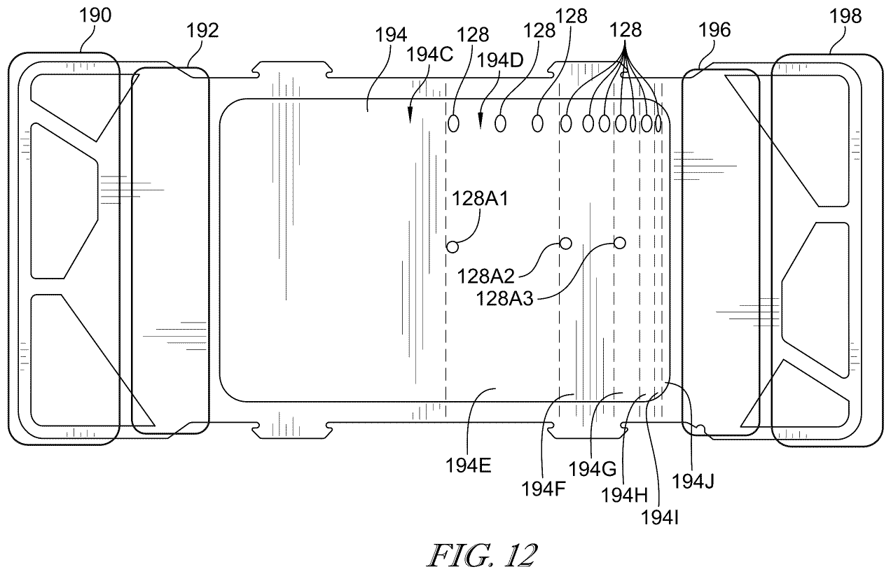

In some embodiments, additional groups of injectors 128 may be located successively downstream of a first group of injectors 128. In particular, a number of additional injectors 128 may increase along the length of the elongated land 116. In some embodiments, as shown in FIG. 12, the active area 194 may be split into a first half 194C and a second half 194D. A first group of injectors 128 may be arranged at an upstream side of the second half 194D closest to the first half 194C. In particular, the first group of injectors 128 may be arranged in a first section 194E of the second half 194D, which is half the length of the second half 194D. As can be seen in FIG. 12, the frequency of the groups of injectors 128 may increase consistently along the length of the second half 194D from the upstream side of the second half 194D to an exhaust side of the second half 194D opposite the upstream side.

In some embodiments, the size of each successive “section” of the second half 194D (i.e. 194E, 194F, 194G, 194H, 194I, 194J) is halved along the length of the second half 194D, as shown in FIG. 12. The frequency of the groups of injectors 128 increases successively as the elongated lands 116 progress through each section 194E, 194F, 194G, 194H, 194I, 194J, as shown in FIG. 12. For example, the first section 194E can include three groups of injectors 128, the second section 194F can include three groups of injectors 128 closer together than those in the first section 194E, the third section 194G can include two groups of injectors 128 closer together than those in the first and second sections 194E, 194F, the fourth section 194H can include one groups of injectors 128, and the fifth section 194I can include one groups of injectors 128. In some embodiments, the number of injectors 128 or the number of groups of injectors 128 may increase in any order or sequence, including linearly, parabolically, and/or logarithmically along the length of the second half 194D.

In some embodiments, instead of groups of injectors 128, the elongated lands 116 may include single injectors 128 formed along the length of the elongated lands 116, as also shown in FIG. 12. In particular, land top surface 120 can further include a first injector 128A1 formed as a hole in the land top surface 120 and located downstream of a second injector 128A2. In some embodiments, the first injector 128A1 is located at an upstream side of the second half 194D of the active area 194 adjacent the first half 194C.

In such an embodiment, the second injector 128A2 is located generally halfway along the length of the second half 194D, as shown in the central portion of the active area 194 in FIG. 12. In some embodiments, the land top surface 120 further includes a third injector 128A3 located downstream of the second injector 128A2. The third injector 128A3 is located generally halfway along a length of the second half 194D measured from the second injector 128A2 to the downstream side of the active area 194.

The above configurations of injectors 128 are merely exemplary. A person skilled in the art will understand that other combinations and arrangements of injectors 128, in particular differing number, locations, orientation, and/or frequency levels, may be utilized based on the design requirements of the bipolar plate assembly 110. Moreover, in some embodiments, a size location, orientation, number and/or frequency of injectors 128, can be based on liquid water accumulation in the bipolar plate assembly 110. In particular embodiments, the size of the injectors 128 is configured to force the fluid 180, in particular the oxygen (or air) 180, past an onset of liquid water accumulation that causes blockage of the adjacent gas diffusion layer 24.

The design and optimization of the injectors 128 as described above is such that the injector convective flow can push past the liquid water and dislodge any blockage from the land area. With an unobstructed matrix of the gas diffusion layers 24, 26, the local MEA 22, and subsequently fuel cell 20 local performance can be restored and potentially improved.

Another improvement of the present disclosure over the standard flow field configuration is the local supply of reactant 32, 34 injected from an upstream source, which has significant advantages with respect to reactant 32, 34 concentration. With regard to FIG. 6, the standard flow field configuration of FIG. 4 results in a monotonic decrease in reactant concentration as a function of channel length and stoich. As the reaction is taking place, the bulk concentration of oxygen 34 will decrease as the oxygen molecules subsidize the MEA 22 over the channel length. However, in the direct injection embodiment of FIGS. 2A, 2B, and 8, the local fuel cell 20 is supplied with the concentration of oxygen 180 upstream the active area 194.

On the other hand, the reactant 32, 34 that is diverted from the primary channel 122 flow to the first secondary channel 118 will cause a steeper reduction in reactant concentration. The high reactant concentration injection is used to “prop up” the performance of the downstream potentially starved and flooded active area 194. The cumulative effect is a more spatial reactant concentration uniformity from inlet to outlet or from distribution area 192 to exhaust area 196. Because local fuel cell 20 performance is largely governed by both reactant concentration and humidity, uniformity in reactant concentration will result in increased uniformity of fuel cell 20 performance.

Illustratively, as shown in FIGS. 2B and 9, the bipolar plate assembly 110 may be part of fuel cell stack 12, which includes a plurality of bipolar plate assemblies 110 each configured as described above

In some embodiments, as shown in FIGS. 9C and 9D, some of the plurality of bipolar plate assemblies 110 are configured as a single-injection assembly 110. Specifically, some of the assemblies 110 include the first fluid 180 flowing through the first secondary channel 118 is oxygen (or air) 180 and the second fluid 181 flowing through the second secondary channel 158 that is aligned with the first secondary channel 118 is coolant 181, as described above in FIG. 9A. FIG. 9C shows the single-injection assembly 110 from the top side. FIG. 9D shows the single-injection assembly 110 from the bottom side.

In some embodiments, some of the plurality of bipolar plate assemblies 110 are configured as dual-injection assemblies in which the first fluid 180 flowing through the first secondary channel 118 is oxygen (or air) 180 and the second fluid 182 flowing through the second secondary channel 158 is hydrogen 182, as shown in FIGS. 9B, 9E, and 9F. In this way, the bipolar plate assembly 110 would not have coolant 181 flowing therethrough. For example, as shown in FIG. 9B, one bipolar plate assembly 110 (upper assembly 110 as shown in FIG. 9B) includes coolant 181 flowing therethrough, while the next bipolar plate assembly 110 on the other side of the adjacent gas diffusion layers 24, 26 and the MEA 22 (lower assembly 110 as shown in FIG. 9B) does not include coolant 181, but instead only hydrogen 182 and oxygen 180OS, 180OP.

In some embodiments, the dual-injection assemblies 110 also include injectors 166 formed in the elongated lands 156 to facilitate fluid flow to the adjacent gas diffusion layer 24, 26, similar to the injectors 128 described herein. The fluid flowing therein may be hydrogen 182 configured to interact with the gas diffusion layer 26, as shown in FIG. 9G. FIG. 9E shows the dual-injection assembly 110 from the top side. FIG. 9F shows the dual-injection assembly 110 from the bottom side.

FIG. 9G shows, on the left side of a central line 186, an exemplary configuration of two dual-injection assemblies 110 arranged on the top and bottom of the MEA 22 and the gas diffusion layer 24, 26 assembly. As indicated by flow direction 183, the oxygen (or air) 1800S is configured to flow out of the injectors 128, through the gas diffusion layer 24, and into the primary channel 122. Similarly, as indicated by flow direction 184, the hydrogen 182 is configured to flow out of the injectors 166, through the gas diffusion layer 26, and into the primary channel 162.

On the right side of the central line 186 of FIG. 9G, two single-injection assemblies 110 are shown arranged on the top and bottom of the MEA 22 and the gas diffusion layer 24, 26 assembly. The oxygen (or air) 180OS is configured to flow out of the injectors 128, through the gas diffusion layer 24, and into the primary channel 122, as shown by flow direction 183. The coolant 181 is configured to flow through the land top surface 160 of the elongated land 156 and cool the MEA 22 and the gas diffusion layer 24, 26 assembly, as shown by flow direction 185.

In some embodiments, the plurality of bipolar plate assemblies 110 are configured as dual-injection assemblies and the remaining assemblies 110 are configured as single-injection assemblies. In some embodiments, a first half of the plurality of bipolar plate assemblies 110 are configured as single-injection assemblies and a second half of the plurality of bipolar plate assemblies 110 are configured as dual-injection assemblies. In some embodiments, the bipolar plate assembly 110 successively alternate between a single-injection assembly and a dual-injection assembly.

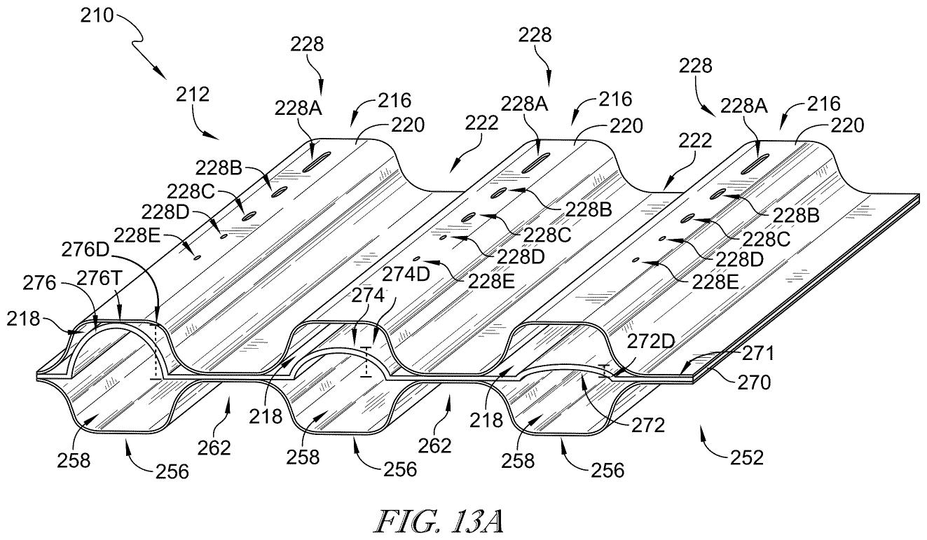

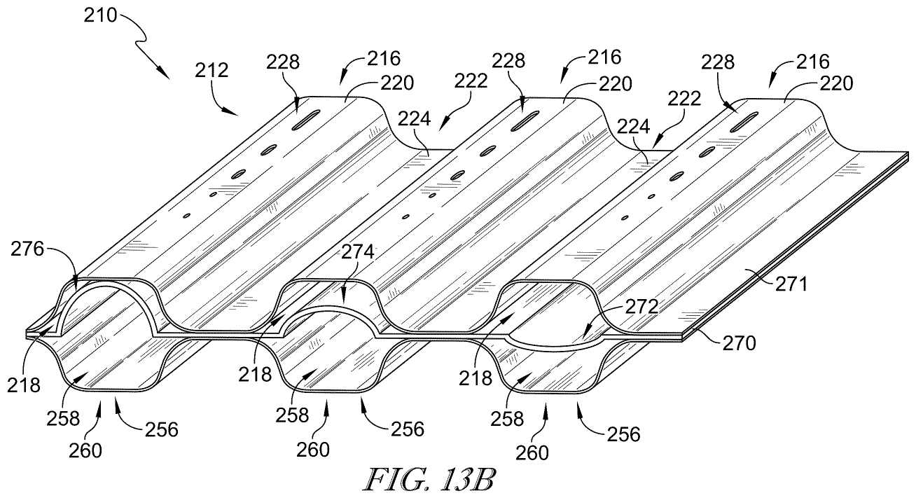

Another embodiment of a bipolar plate assembly 210 in accordance with the present disclosure is shown in FIGS. 13A and 13B. The bipolar plate assembly 210 is substantially similar to the bipolar plate assembly 110 described herein. Accordingly, similar reference numbers in the 200 series indicate features that are common between the bipolar plate assembly 210 and the bipolar plate assembly 110. The description of the bipolar plate assembly 110 is incorporated by reference to apply to the bipolar plate assembly 210, except in instances when it conflicts with the specific description and the drawings of the bipolar plate assembly 210. Any combination of the components of the bipolar plate assembly 110 and the bipolar plate assembly 210 described in further detail below may be utilized in an assembly of the present disclosure.

Similar to the bipolar plate assembly 110, the bipolar plate assembly 210 includes similar first and second bipolar sheets 212, 252 having similar components and features as the bipolar sheets 112, 152 described above, including elongated lands 216, 256, secondary channels 218, 258 formed therein, and primary channels 222, 262. Illustratively, a plurality of injectors 228 (e.g., 228A, 228B, 228C, 228D, 228E, etc.) are formed on the land top surface 220 of the elongated lands 216, as shown in FIGS. 13A and 13B. The primary channels 222 are defined by outer surfaces of two adjacent elongated lands 216. Each primary channel 222 includes a channel bottom surface 224.

Illustratively, a separator sheet 270 includes elongated protrusions 272, 274, 276 that extend generally parallel with a longitudinal extent of corresponding elongated lands 216. The elongated protrusions 272, 274, 276 are raised away from a separator sheet surface 271 toward land top surfaces 220. The elongated protrusions 272, 274, 276 are located within the first secondary channels 218 of the elongated land 216 and are configured to reduce a volume of the first secondary channel 218 of the respective elongated land 216. In some embodiments, one or more of the elongated protrusions 272, 274, 276 may be raised away from the separator sheet surface 271 toward land top surfaces 260 of the elongated lands 256 of the second bipolar sheet 252, such as the elongated protrusion 272 shown in FIG. 13B.

Illustratively, elongated protrusions 272, 274, 276 may be formed with varying heights, as shown in FIGS. 13A and 13B. In some embodiments, a first distance 276D between a top of a first elongated protrusion 276 and the associated first land top surface 220 is less than a second distance 274D between a top of a second elongated protrusion 274 and the associated second land top surface 220. A third distance 272D between a top of a third protrusion 272 and the associated third land top surface 220 may be less than the first and/or second distances 276D, 274D, as also shown in FIGS. 13A and 13B.

In some embodiments, the top 276T of the first elongated protrusion 276 contacts an underside of the first land top surface 220 so as to provide structural support to the first elongated land 216. In some embodiments, the top 276T of the first elongated protrusion 276 contacts the underside of the first land top surface 220 along an entirety of the first elongated protrusion 276. In some embodiments, portions of the top 276T of the first elongated protrusion 276 contact an underside of the first land top surface 220 and some other portions of the top 276T of the first elongated protrusion 276 do not contact the underside of the first land top surface 220 so as to provide a staggered contact arrangement with more limited support along the length of the elongated land 216.

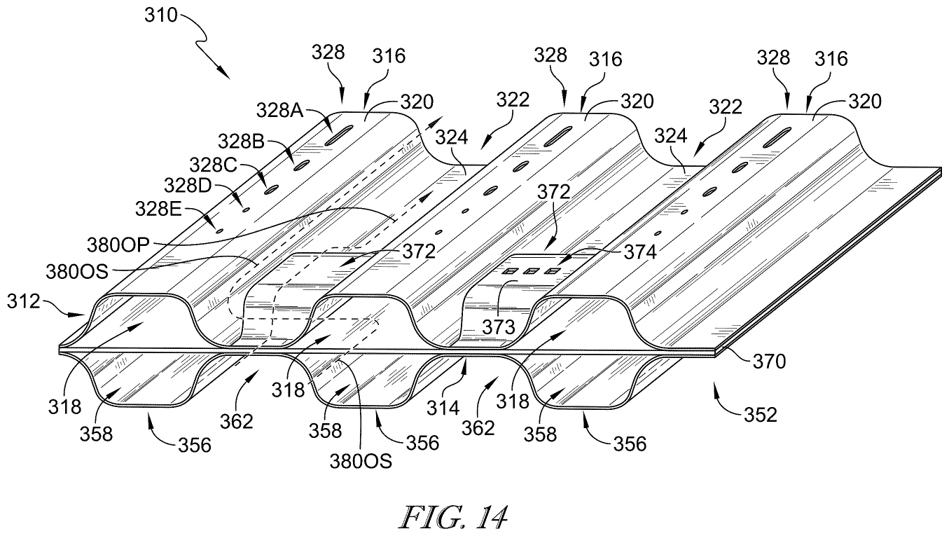

Another embodiment of a bipolar plate assembly 310 in accordance with the present disclosure is shown in FIG. 14. The bipolar plate assembly 310 is substantially similar to the bipolar plate assemblies 110, 210 described herein. Accordingly, similar reference numbers in the 300 series indicate features that are common between the bipolar plate assembly 310 and the bipolar plate assemblies 110, 210. The description of the bipolar plate assemblies 110, 210 are incorporated by reference to apply to the bipolar plate assembly 310, except in instances when they conflict with the specific description and the drawings of the bipolar plate assembly 310. Any combination of the components of the bipolar plate assemblies 110, 210 and the bipolar plate assembly 310 described in further detail below may be utilized in an assembly of the present disclosure.

Similar to the bipolar plate assemblies 110, 210, the bipolar plate assembly 310 includes similar first and second bipolar sheets 312, 352 having similar components and features as the bipolar sheets 112, 212, 152, 252 described above, including lands 316, 356, secondary channels 318, 358 formed therein, and primary channels 322, 362. A separator plate 370 is arranged between the first and second bipolar sheets 312, 352. The primary channels 322 are defined by outer surfaces of two adjacent elongated lands 316. Each primary channel 322 includes a channel bottom surface 324. Illustratively, a plurality of injectors 328 (e.g., 328A, 328B, 328C, 328D, 328E, etc.) are formed on the land top surface 320 of the elongated lands 316.

Illustratively, the first bipolar sheet 312 may further include connecting elongated ducts 372 that are raised away from a first sheet surface 314. The connecting elongated ducts 372 are formed as hollow channels so as to define connecting channels therein. The connecting elongated ducts 372 extend between and fluidically interconnect adjacent elongated lands 316 so as to allow a first fluid 380OS flowing through the first secondary channel 318 to flow between the first secondary channels 318 of adjacent elongated lands 316.

In some embodiments, a portion 380OP of the first fluid 380 or oxygen (or air) 380, is configured to enter the primary channel 322 upstream of the connecting elongated duct 372. The fluid 380 enters the primary channel 322 via an additional injector 328 upstream of the connecting elongated duct 372 or an input end (not shown) of the primary channel 322. This input end (not shown) is similar to the input ends 123 described above.

An additional portion 380OS of the oxygen 380 is configured to flow from an input end (not shown) of a second secondary channel 318 of a second elongated land 316 (middle elongated land 316 in FIG. 14), through the connecting elongated duct 372, and into a first secondary channel 318 of a first elongated land 316 (leftmost elongated land 316 in FIG. 14). In some embodiments, the second elongated land 316 can be connected to the first elongated land 316 via an additional connecting elongated duct 372 located upstream of the (first) connecting elongated duct 372. In some embodiments, an input end (not shown) of the first secondary channel 318 of the first elongated land 316 may allow additional oxygen 380 to enter the first secondary channel 318. The input ends (not shown) of the secondary channels 318 may be similar to the input ends 119 described above.

The portion 380OP of the oxygen 380 flowing through the primary channel 322 flows over the connecting elongated duct 372 so as to increase a pressure difference between the first secondary channel 318 of the first elongated land 316 and the primary channel 322. The increased pressure difference causes the oxygen 380 to flow out of the first injector 328, through the adjacent gas diffusion layer 24, and into an adjacent primary channel 322. In some embodiments, the elongated duct 372 may include injectors 374 formed on a top surface 373 thereof (shown in the additional connecting elongated duct 372 in FIG. 14). The injectors 374 enable addition of concentration to the down-stream primary channel 322 without the injection into the gas diffusion layer 24, 26, thus providing a concentration advantage.

In some embodiments, the connecting elongated duct 372 is located upstream of a first injector 328 (leftmost injectors 328), as shown in FIG. 14. In some embodiments, the plurality of elongated lands 316 further include additional elongated lands 316 (at least the rightmost elongated land 316 in FIG. 14) in addition to the first and second elongated lands 316 (leftmost two lands 316 in FIG. 14). The first, second, and additional elongated lands 316 are generally parallel with each other. In some embodiments, every elongated land 316 includes injectors 328. In some embodiments, every other elongated land 316 of the first, second, and additional elongated lands 316 includes an injector 328 formed as a hole in a top surface 320 of the elongated land 316.

In some embodiments, primary channels 322 or first secondary channels 318 that are part of a furcated active area 194 channel (e.g., left side of FIG. 10) whose starting elongated land 316 locations are not located near the inlet manifold region 190 may not need a dedicated inlet within the active area 194. Material discontinuity within the flow field may introduce risks for the gas diffusion layer 24, 26 and the MEA 22, specifically the formation of sharp edges that can cause lacerations to the delicate materials. The elongated ducts 372 enable an internal fluidic connection which rids the need for the fluidic opening to the primary and/or secondary channels 322, 318 within the active area 194.

Moreover, the local connecting elongated ducts 372 for the first secondary channels 318 simultaneously act as a speedbump or pressure restriction for the primary channel 322. The local restriction causes a pressure drop spike in the primary channel 322. Because the first secondary channel 318 flow is passive, it relies on a difference in local static pressure at the injectors 328 and between the primary and secondary channels 322, 318. By including the connecting elongated ducts 372, there is an additional design feature which can be used repeatedly to ensure the desired local pressure difference between the primary and secondary channels 322, 318 is maintained. The connecting elongated ducts 372 enable the use of an increased quantity of injectors 328, and location freedom, with less concern for an adequate pressure delta between the primary and secondary channels 322, 318 to drive the injector 328 flow.

A method of forming a bipolar plate assembly 110, 210, 310 for a fuel cell 20 includes providing a first bipolar sheet 112, 212, 312 defining a first sheet surface 114, 214, 314. The method includes forming a plurality of elongated lands 116, 216, 316 that are raised away from the first sheet surface 114, 214, 314 and formed as hollow channels so as to each define a first sheet secondary channel 118, 218, 318 therein. The plurality of elongated lands 116, 216, 316 extend from a distribution area 192 of the first bipolar sheet 112, 212, 312 to an exhaust area 196 of the first bipolar sheet 112, 212, 312.

The plurality of elongated lands 116, 216, 316 include a first elongated land 116, 216, 316 having a first land top surface 120, 220, 320 and a second elongated land 116, 216, 316 having a second land top surface 120, 220, 320. The method includes forming a first sheet primary channel 122, 222, 322 between the first and second elongated lands 116, 216, 316. The first bipolar sheet 112, 212, 312 includes an active area 194 at which fluids flowing through the first sheet primary channel 122, 222, 322 and first sheet secondary channels 118, 218, 318 are operable to electrochemically react with an adjacent gas diffusion layer 24, 26 of the fuel cell 20.

The method includes forming a first ejector 128 in the first land top surface 120, 220, 320. The first injector 128 is formed as a hole in the first land top surface 120, 220, 320. The first injector 128 is located in the active area 194 of the first bipolar sheet 112, 212, 312. The first sheet secondary channel 118, 218, 318 of the first elongated land 116, 216, 316 is configured to facilitate flow of a first fluid 180 therethrough. The first fluid 180 is configured to be forced through the first injector 128, subsequently into the adjacent gas diffusion layer 24, 26, and subsequently into the first sheet primary channel 122, 222, 322.

A first aspect of the present invention relates to a bipolar plate assembly for a fuel cell includes a first bipolar sheet defining a first sheet surface. The first bipolar sheet includes a plurality of elongated lands that are raised away from the first sheet surface and formed as hollow channels so as to each define a first sheet secondary channel therein. The plurality of elongated lands extend from an inlet portion of the first bipolar sheet to an exhaust portion of the first bipolar sheet. The plurality of elongated lands include a first elongated land having a first land top surface and a second elongated land having a second land top surface. A first sheet primary channel is formed between the first and second elongated lands. The first bipolar sheet includes an active area at which fluids flowing through the first sheet primary channel and first sheet secondary channel are operable to electrochemically react with an adjacent gas diffusion layer of the fuel cell. The first land top surface includes a first injector formed as a hole in the first land top surface and located in the active area of the first bipolar sheet. A first fluid flowing through the first sheet secondary channel of the first elongated land is forced through the first injector, subsequently into the adjacent gas diffusion layer, and subsequently into the first sheet primary channel.

A second aspect of the present invention relates to a bipolar plate sheet for a bipolar plate of a fuel cell includes a plurality of elongated lands that are raised away from a first sheet surface of the bipolar plate sheet and formed as hollow channels so as to each define a secondary channel therein. The plurality of elongated lands includes a first elongated land having a first land top surface and a second elongated land having a second land top surface. A primary channel is formed between the first and second elongated lands. The first land top surface includes a first injector formed as a hole in the first land top surface. A first fluid flowing through the secondary channel of the first elongated land is forced through the first injector, subsequently into an adjacent gas diffusion layer, and subsequently into the primary channel.

A third aspect of the present invention relates to a method of forming bipolar plate assembly for a fuel cell includes providing a first bipolar sheet defining a first sheet surface. The method includes forming a plurality of elongated lands that are raised away from the first sheet surface and formed as hollow channels so as to each define a first sheet secondary channel therein. The plurality of elongated lands extend from an inlet portion of the first bipolar sheet to an exhaust portion of the first bipolar sheet. The plurality of elongated lands include a first elongated land having a first land top surface and a second elongated land having a second land top surface. The method includes forming a first sheet primary channel between the first and second elongated lands. The first bipolar sheet includes an active area at which fluids flowing through the first sheet primary channel and first sheet secondary channels are operable to electrochemically react with an adjacent gas diffusion layer of the fuel cell. The method includes forming a first ejector in the first land top surface. The first injector is formed as a hole in the first land top surface and located in the active area of the first bipolar sheet. The first sheet secondary channel of the first elongated land is configured to facilitate flow of a first fluid therethrough. The first fluid is configured to be forced through the first injector, subsequently into the adjacent gas diffusion layer, and subsequently into the first sheet primary channel.

A fourth aspect of the present invention relates to a fuel cell assembly. The fuel cell assembly includes a plurality of bipolar plate assemblies. Each of the plurality of bipolar plate assemblies includes a first bipolar sheet defining a first sheet surface having a plurality of elongated lands that are raised away from the first sheet surface and a first sheet primary channel formed between two elongated lands of the plurality of elongated lands. Each of the plurality of bipolar plate assemblies includes a second bipolar sheet arranged on an underside of the first bipolar sheet and defining a second sheet surface. The second bipolar sheet has a plurality of elongated lands that are raised away from the second sheet surface in a second direction opposite a first direction in which the plurality of elongated lands of the first bipolar sheet extend. A second sheet primary channel is formed between the two elongated lands of the plurality of elongated lands. Each of the plurality of bipolar plate assemblies includes a separator plate arranged between the first bipolar sheet and the second bipolar sheet. Each of the plurality of bipolar plate assemblies includes a plurality of gas diffusion layers. Each gas diffusion layer is arranged between two bipolar plate assemblies of the plurality of bipolar plate assemblies. Each bipolar plate assembly includes an active area at which fluids flowing through the primary channels and through the elongated lands are operable to electrochemically react with an adjacent gas diffusion layer of the plurality of gas diffusion layers. One of the plurality of elongated lands of the first bipolar sheet of each bipolar plate assembly includes a first injector formed as a hole in a top surface of the elongated land and located in the active area. A first fluid flowing through a first secondary channel defined within a first elongated land of the plurality of elongated lands of the first bipolar sheet and delimited by the separator plate is forced through the first injector, subsequently into the adjacent gas diffusion layer, and subsequently into the first sheet primary channel

In the first aspect of the present invention, the bipolar plate assembly may further include a second bipolar sheet defining a second sheet surface and arranged on an underside of the first bipolar sheet. In the first aspect of the present invention, the second bipolar sheet may include a plurality of elongated lands that are raised away from the second sheet surface in a second direction opposite a first direction in which the plurality of elongated lands of the first bipolar sheet extend.

In the first aspect of the present invention, the plurality of elongated lands of the second bipolar sheet may be formed as hollow channels so as to each define a second sheet secondary channel therein. In the first aspect of the present invention, the plurality of elongated lands of the second bipolar sheet may extend from an inlet portion of the second bipolar sheet to an exhaust portion of the second bipolar sheet. In the first aspect of the present invention, the plurality of elongated lands of the second bipolar sheet may include a third elongated land having a third land top surface and a fourth elongated land having a fourth land top surface. In the first aspect of the present invention, a second sheet primary channel may be formed between the third and fourth elongated lands.

In the first aspect of the present invention, the third and fourth elongated lands may be aligned with the first and second elongated lands, respectively. In the first aspect of the present invention, the first sheet primary channel may be aligned with the second sheet primary channel. In the first aspect of the present invention, the third and fourth land top surfaces may be generally parallel with the first and second land top surfaces. In the first aspect of the present invention, a bottom surface of the first sheet primary channel may be generally parallel with a bottom surface of the second sheet primary channel.

In the first aspect of the present invention, the bipolar plate assembly may further include a separator plate arranged between the first and second bipolar sheets. In the first aspect of the present invention, the separator plate may extend between each first sheet secondary channel and the corresponding second sheet secondary channel such that each first sheet secondary channel is separated from and selectively sealed off from the corresponding second sheet secondary channel. In the first aspect of the present invention, the first sheet secondary channel defined between the first elongated land and the separator plate may include a first fluid flowing therethrough.

In the first aspect of the present invention, the first fluid may be oxygen or air. In the first aspect of the present invention, the oxygen or air flowing through the first sheet secondary channel defined between the first elongated land and the separator plate, through the adjacent gas diffusion layer, and into the first sheet primary channel may increase uniformity of a concentration of oxygen or air between the inlet portion and the exhaust portion of the first bipolar sheet.

In the first aspect of the present invention, an input end of the first elongated land located at the input portion of the first bipolar sheet may be opened so as to allow input of the first fluid into the first sheet secondary channel of the first elongated land. In the first aspect of the present invention, an input end of the first sheet primary channel located at the inlet portion of the first bipolar sheet may be opened so as to allow additional input of the first fluid into the first sheet primary channel.

In the first aspect of the present invention, the first bipolar sheet may include a total amount of first fluid flowing through the first sheet primary and secondary channels, wherein a first percentage of the total amount of first fluid may be input through the input end of the first sheet primary channel and a remaining percentage of the total amount of first fluid defined as 100% minus the first percentage may be input through the input end of the first sheet secondary channel of the first elongated land. In the first aspect of the present invention, the first percentage may be 0%.

In the first aspect of the present invention, the second sheet secondary channel defined between the third elongated land and the separator plate may include a second fluid flowing therethrough. In the first aspect of the present invention, the second fluid may be different than the first fluid. In the first aspect of the present invention, the second fluid may be a coolant. In the first aspect of the present invention, a third fluid may flow through the second sheet primary channel, and the third fluid may be hydrogen.

In the first aspect of the present invention, an output end of the first elongated land located at the exhaust portion of the first bipolar sheet may be closed so as to cause a pressure drop in the fluid flowing through the first sheet secondary channel of the first elongated land such that the fluid is forced through the first injector.

In the first aspect of the present invention, an input end of the first elongated land opposite the output end may be opened so as to allow input of the first fluid into the first sheet secondary channel of the first elongated land, and wherein the input end of the first elongated land may be located in a distribution area of the inlet portion of the first bipolar sheet located upstream of the active area of the first bipolar sheet.

In the first aspect of the present invention, the plurality of elongated lands of the first bipolar sheet may further include a fifth elongated land that extends from an inlet side of the active area of the first bipolar sheet to an exhaust side of the active area of the first bipolar plate. In the first aspect of the present invention, an input end of the fifth elongated land may be opened so as to allow input of the first fluid into the first sheet secondary channel of the fifth elongated land at the inlet side of the active area of the first bipolar sheet.

In the first aspect of the present invention, a size of the first injector may be based on liquid water accumulation in the bipolar plate assembly. In the first aspect of the present invention, the size of the first injector may be configured to force the first fluid past an onset of liquid water accumulation that causes blockage of the adjacent gas diffusion layer.

In the first aspect of the present invention, the plurality of elongated lands of the first bipolar sheet may further include additional elongated lands in addition to the first and second elongated lands. In the first aspect of the present invention, the first, second, and additional elongated lands may be generally parallel with each other.

In the first aspect of the present invention, the separator plate may include a first elongated protrusion that extends generally parallel with a longitudinal extent of the first elongated land and that is raised away from a separator plate surface toward the first land top surface. In the first aspect of the present invention, the first elongated protrusion may be located within the first sheet secondary channel of the first elongated land. In the first aspect of the present invention, the first elongated protrusion may be configured to reduce a volume of the first sheet secondary channel of the first elongated land.

In the first aspect of the present invention, the separator plate sheet may further include a second elongated protrusion that extends generally parallel with a longitudinal extent of the second elongated land and that is raised away from the separator plate sheet surface toward the second land top surface. In the first aspect of the present invention, the second elongated protrusion may be located within the first sheet secondary channel of the second elongated land. In the first aspect of the present invention, the second elongated protrusion may be configured to reduce a volume of the first sheet secondary channel of the second elongated land.

In the first aspect of the present invention, a first distance between a top of the first elongated protrusion and the first land top surface may be less than a second distance between a top of the second elongated protrusion and the second land top surface. In the first aspect of the present invention, the top of the first elongated protrusion may contact an underside of the first land top surface so as to provide structural support to the first elongated land.

In the first aspect of the present invention, the top of the first elongated protrusion may contact the underside of the first land top surface along an entirety of the first elongated protrusion. In the first aspect of the present invention, portions of the top of the first elongated protrusion may contact the underside of the first land top surface and some other portions of the top of the first elongated protrusion may not contact the underside of the first land top surface.

In the first aspect of the present invention, the plurality of elongated lands of the second bipolar sheet may further include additional elongated lands in addition to the third and fourth elongated lands. In the first aspect of the present invention, the third, fourth, and additional elongated lands may be generally parallel with each other. In the first aspect of the present invention, the separator plate sheet may include a third elongated protrusion that extends generally parallel with a longitudinal extent of the third elongated land and that is raised away from a separator plate sheet surface toward the third land top surface.

In the first aspect of the present invention, the third elongated protrusion may be located within the second sheet secondary channel of the third elongated land. In the first aspect of the present invention, the third elongated protrusion may be configured to reduce a volume of the second sheet secondary channel of the third elongated land.

In the second aspect of the present invention, the first bipolar sheet may include an active area at which fluids flowing through the primary channel and secondary channels are operable to electrochemically react with the adjacent gas diffusion layer of the fuel cell. In the second aspect of the present invention, the first injector may be located in the active area. In some embodiments, the first fluid may be a reactant of the fuel cell. In the second aspect of the present invention, the first and second land top surfaces may be generally parallel with a bottom surface of the primary channel.

In the second aspect of the present invention, the active area may be located between a distribution area of the bipolar plate sheet and an exhaust area of the bipolar plate. In the second aspect of the present invention, the active area may include a first half located closest to the distribution area and a second half located closest to the exhaust area. In the second aspect of the present invention, the first injector may be located in the second half of the active area. In the second aspect of the present invention, the first land top surface may further include a second injector formed as a hole in the first land top surface and located downstream of the first injector.

In the second aspect of the present invention, the first injector may be located at an upstream side of the second half of the active area adjacent the first half. In the second aspect of the present invention, the second injector may be located generally halfway along a first length of the second half of the active area measured from the first injector to a downstream side of the active area opposite the upstream side. In the second aspect of the present invention, the first land top surface may further include a third injector formed as a hole in the first land top surface and located downstream of the second injector.

In the second aspect of the present invention, the third injector may be located generally halfway along a second length of the second half of the active area measured from the second injector to the downstream side of the active area. In the second aspect of the present invention, the first land top surface may further include a plurality of additional injectors formed as holes in the first land top surface and located successively downstream of the first injector. In the second aspect of the present invention, a number of additional injectors may increase one of linearly, parabolically, or logarithmically along a first length of the second half of the active area measured from the first injector to a downstream side of the active area opposite the upstream side one of linearly, parabolically, or logarithmically.

In the second aspect of the present invention, the first injector may be one of circular, triangular, or rectangular shaped. In the second aspect of the present invention, the first injector may be part of a group of first injectors. In the second aspect of the present invention, each injector of the group of first injectors may be spaced apart from each other. In the second aspect of the present invention, a length of each injector of the group of first injectors as measured in a longitudinal direction of the first elongated land may increase for each successive injector along the longitudinal direction.

In the second aspect of the present invention, the bipolar plate sheet may further comprise a connecting elongated land that is raised away from the first sheet surface and formed as a hollow channel so as to define a connecting channel therein. In the second aspect of the present invention, the connecting elongated land may extend between and fluidically interconnect the first elongated land and the second elongated land so as to allow the first fluid to flow between the first and second elongated lands.

In the second aspect of the present invention, a portion of the first fluid may be configured to enter the primary channel upstream of the connecting elongated land via one of an additional injector upstream of the connecting elongated land or an inlet end of the primary channel. In the second aspect of the present invention, an additional portion of the first fluid may be configured to enter the secondary channel of the first elongated land upstream of the connecting elongated land via one of an additional elongated land connected to the first elongated land via an additional connecting elongated land located upstream of the connecting elongated land or an inlet end of the secondary channel of the first elongated land. In the second aspect of the present invention, the portion of the first fluid flowing through the primary channel may flow over the connecting elongated land so as to increase a pressure difference between the secondary channel of the first elongated land and the primary channel so as to cause the first fluid to flow out of the first injector, through the adjacent gas diffusion layer, and into the primary channel.

In the second aspect of the present invention, the connecting elongated land may be located upstream of the first injector. In the second aspect of the present invention, the plurality of elongated lands may further include additional elongated lands in addition to the first and second elongated lands. In the second aspect of the present invention, the first, second, and additional elongated lands may be generally parallel with each other.

In the second aspect of the present invention, each additional elongated land may include an injector formed as a hole in a top surface of the additional elongated land. In the second aspect of the present invention, every other land of the first, second, and additional elongated lands may include an injector formed as a hole in a top surface of the elongated land.

In the fourth aspect of the present invention, some of the plurality of bipolar plate assemblies may be configured as single-injection assemblies in which the first fluid flowing through the first secondary channel is oxygen or air and a second fluid flowing through a second secondary channel defined within a second elongated land of the second bipolar sheet that is aligned with the first elongated land of the first bipolar sheet and delimited by the separator plate is coolant. In the fourth aspect of the present invention, some of the plurality of bipolar plate assemblies may be configured as dual-injection assemblies in which the first fluid flowing through the first secondary channel is oxygen or air and the second fluid flowing through the second secondary channel is hydrogen.

In the fourth aspect of the present invention, a first half of the plurality of bipolar plate assemblies may be configured as single-injection assemblies and a second half of the plurality of bipolar plate assemblies may be configured as dual-injection assemblies. In the fourth aspect of the present invention, the plurality of bipolar plate assemblies may successively alternate between a single-injection assembly and a dual-injection assembly.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A bipolar plate assembly for a fuel cell, comprising:
a first bipolar sheet defining a first sheet surface, the first bipolar sheet including:
a plurality of elongated lands that are raised away from the first sheet surface and formed as hollow channels so as to each define a first sheet secondary channel therein, the plurality of elongated lands extending from an inlet portion of the first bipolar sheet to an exhaust portion of the first bipolar sheet, the plurality of elongated lands including a first elongated land having a first land top surface and a second elongated land having a second land top surface; and
a first sheet primary channel formed between the first and second elongated lands,
wherein the first bipolar sheet includes an active area at which fluids flowing through the first sheet primary channel and the first sheet secondary channel are operable to electrochemically react with an adjacent gas diffusion layer of the fuel cell, wherein the first land top surface includes a first injector formed as a hole in the first land top surface and located in the active area of the first bipolar sheet, and wherein a first fluid flowing through the first sheet secondary channel of the first elongated land is forced through the first injector, subsequently into the adjacent gas diffusion layer, and subsequently into the first sheet primary channel.

2. The bipolar plate assembly of claim 1, further comprising:
a second bipolar sheet defining a second sheet surface and arranged on an underside of the first bipolar sheet, the second bipolar sheet including:
a plurality of elongated lands that are raised away from the second sheet surface in a second direction opposite a first direction in which the plurality of elongated lands of the first bipolar sheet extend, the plurality of elongated lands of the second bipolar sheet formed as hollow channels so as to each define a second sheet secondary channel therein, the plurality of elongated lands of the second bipolar sheet extending from an inlet portion of the second bipolar sheet to an exhaust portion of the second bipolar sheet, the plurality of elongated lands of the second bipolar sheet including a third elongated land having a third land top surface and a fourth elongated land having a fourth land top surface; and
a second sheet primary channel formed between the third and fourth elongated lands.

3. The bipolar plate assembly of claim 2, wherein the third and fourth elongated lands are aligned with the first and second elongated lands, respectively, and wherein the first sheet primary channel is aligned with the second sheet primary channel.

4. The bipolar plate assembly of claim 3, wherein the third and fourth land top surfaces are generally parallel with the first and second land top surfaces, and wherein a bottom surface of the first sheet primary channel is generally parallel with a bottom surface of the second sheet primary channel.

5. The bipolar plate assembly of claim 4, further comprising:
a separator plate arranged between the first and second bipolar sheets,
wherein the separator plate extends between each first sheet secondary channel and the corresponding second sheet secondary channel such that each first sheet secondary channel is separated from and selectively sealed off from the corresponding second sheet secondary channel.

6. The bipolar plate assembly of claim 5, wherein the first sheet secondary channel defined between the first elongated land and the separator plate includes the first fluid flowing therethrough.

7. The bipolar plate assembly of claim 6, wherein the first fluid is oxygen or air, and wherein the oxygen or air flowing through the first sheet secondary channel defined between the first elongated land and the separator plate, through the adjacent gas diffusion layer, and into the first sheet primary channel increases uniformity of a concentration of oxygen or air between the inlet portion and the exhaust portion of the first bipolar sheet.

8. The bipolar plate assembly of claim 6, wherein an input end of the first elongated land located at the inlet portion of the first bipolar sheet is opened so as to allow input of the first fluid into the first sheet secondary channel of the first elongated land.

9. The bipolar plate assembly of claim 7, wherein the second sheet secondary channel defined between the third elongated land and the separator plate includes a second fluid flowing therethrough, and wherein the second fluid is different than the first fluid.

10. The bipolar plate assembly of claim 1, wherein an output end of the first elongated land located at the exhaust portion of the first bipolar sheet is closed so as to cause a pressure drop in the first fluid flowing through the first sheet secondary channel of the first elongated land such that the first fluid is forced through the first injector.

11. The bipolar plate assembly of claim 1, wherein a size of the first injector is based on liquid water accumulation in the bipolar plate assembly.

12. The bipolar plate assembly of claim 11, wherein the size of the first injector is configured to force the first fluid past an onset of liquid water accumulation that causes blockage of the adjacent gas diffusion layer.

13. The bipolar plate assembly of claim 5, wherein the separator plate includes a first elongated protrusion that extends generally parallel with a longitudinal extent of the first elongated land and that is raised away from a separator plate surface toward the first land top surface, wherein the first elongated protrusion is located within the first sheet secondary channel of the first elongated land, and wherein the first elongated protrusion is configured to reduce a volume of the first sheet secondary channel of the first elongated land.

14. A bipolar plate sheet for a bipolar plate of a fuel cell, comprising:
a plurality of elongated lands that are raised away from a first sheet surface of the bipolar plate sheet and formed as hollow channels so as to each define a secondary channel therein, the plurality of elongated lands including a first elongated land having a first land top surface and a second elongated land having a second land top surface; and
a primary channel formed between the first and second elongated lands,
wherein the first land top surface includes a first injector formed as a hole in the first land top surface, and wherein a first fluid flowing through the secondary channel of the first elongated land is forced through the first injector, subsequently into an adjacent gas diffusion layer, and subsequently into the primary channel.

15. The bipolar plate sheet of claim 14, wherein the first bipolar sheet includes an active area at which fluids flowing through the primary channel and secondary channel are operable to electrochemically react with the adjacent gas diffusion layer of the fuel cell, and wherein the first injector is located in the active area.

16. The bipolar plate sheet of claim 15, wherein the first fluid is a reactant of the fuel cell.

17. The bipolar plate sheet of claim 15, wherein the first and second land top surfaces are generally parallel with a bottom surface of the primary channel.

18. The bipolar plate sheet of claim 15, wherein the active area is located between a distribution area of the bipolar plate sheet and an exhaust area of the bipolar plate sheet, wherein the active area includes a first half located closest to the distribution area and a second half located closest to the exhaust area, and wherein the first injector is located in the second half of the active area.

19. The bipolar plate sheet of claim 18, wherein the first land top surface further includes a second injector formed as a hole in the first land top surface and located downstream of the first injector.

20. A method of forming a bipolar plate assembly for a fuel cell, comprising:
providing a first bipolar sheet defining a first sheet surface;
forming a plurality of elongated lands that are raised away from the first sheet surface and formed as hollow channels so as to each define a first sheet secondary channel therein, the plurality of elongated lands extending from an inlet portion of the first bipolar sheet to an exhaust portion of the first bipolar sheet, the plurality of elongated lands including a first elongated land having a first land top surface and a second elongated land having a second land top surface;
forming a first sheet primary channel between the first and second elongated lands, wherein the first bipolar sheet includes an active area at which fluids flowing through the first sheet primary channel and first sheet secondary channels are operable to electrochemically react with an adjacent gas diffusion layer of the fuel cell; and
forming a first ejector in the first land top surface, the first injector formed as a hole in the first land top surface and located in the active area of the first bipolar sheet,
wherein the first sheet secondary channel of the first elongated land is configured to facilitate flow of a first fluid therethrough, the first fluid configured to be forced through the first injector, subsequently into the adjacent gas diffusion layer, and subsequently into the first sheet primary channel.
